(19) United States
(12) Patent Application Publication
(10) Pub. No.: US 2021/0158376 A1
(43) Pub. Date: May 27, 2021

(54) METHODS, SYSTEMS AND APPARATUS TO ESTIMATE CENSUS-LEVEL AUDIENCE, IMPRESSIONS, AND DURATIONS ACROSS DEMOGRAPHICS

(71) Applicant: The Nielsen Company (US), LLC, New York, NY (US)

(72) Inventors: Michael Sheppard, Holland, MI (US); Ludo Daemen, Duffel (BE); Edward Murphy, North Stonington, CT (US); Beate Sissenich, New York, NY (US); Edmond Wong, New York, NY (US); Jing Liu, Jersey City, NJ (US)

(21) Appl. No.: 16/698,147

(22) Filed: Nov. 27, 2019

(51) Int. Cl. G06Q 30/02; G06F 16/9536

(52) U.S. Cl. CPC G06Q 30/0201; G06F 16/9536; G06Q 30/0246

(57) ABSTRACT

Methods, apparatus, and systems are disclosed for determining census-level audience metrics across demographics. An example apparatus disclosed herein includes a distribution parameter solver to initialize distribution parameter values for a probability of an individual within a demographic being included in a subscriber audience for the demographic, having a first average impression count, and having a first average impression duration, the subscriber audience having a first subscriber audience size, a divergence parameter solver to determine divergence parameter values between (i) the subscriber audience size, the first impression count, and the first impression duration and (ii) a census-level audience size, a second impression count, and a second impression duration based on the initialized distribution parameter values, a search space identifier to identify a search space within bounds based on a census-level total impression count and a census-level total impression duration, the search space to define an equality constraint.

### FIELD OF THE DISCLOSURE

This disclosure relates generally to computer processing, and, more particularly, to methods, systems, and apparatus to estimate census-level audience, impressions, and durations across demographics.

### BACKGROUND

Media content is accessible to users through a variety of platforms. For example, media content can be viewed on television sets, via the Internet, on mobile devices, in-home or out-of-home, live or time-shifted, etc. Understanding consumer-based engagement with media within and across a variety of platforms (e.g., television, online, mobile, and emerging) allows content providers and website developers to increase user engagement with their media content.

### BRIEF DESCRIPTION OF THE DRAWINGS

FIG. 1 is a block diagram illustrating an example operating environment, constructed in accordance with teachings of this disclosure, in which an audience metrics estimator is implemented to determine census-level audience, impressions, and durations across demographics.

FIG. 2 is a block diagram of an example implementation of the audience metrics estimator of FIG. 1.

FIG. 3 is a flowchart representative of machine readable instructions which may be executed to implement elements of the example audience metrics estimator of FIGS. 1-2.

FIG. 4 is a flowchart representative of machine readable instructions which may be executed to implement elements of the example audience metrics estimator of FIGS. 1-2, the flowchart representative of instructions used to generate probability distributions.

FIG. 5 is a flowchart representative of machine readable instructions which may be executed to implement elements of the example audience metrics estimator of FIGS. 1-2, the flowchart representative of instructions used to determine probability divergences.

FIG. 6 is a flowchart representative of machine readable instructions which may be executed to implement elements of the example audience metrics estimator of FIGS. 1-2, the flowchart representative of instructions used to evaluate probability divergence parameters of FIG. 5.

FIGS. 7A-7D include example programming code representative of machine readable instructions that may be executed to implement the example audience metrics estimator of FIGS. 1-2 to estimate census-level unique audience size, census-level impression count, and census-level impression duration across multiple demographics based on third-party subscriber data and census-level data total impression count and total impression duration.

FIG. 8A includes an example set of variables used to define third-party subscriber and census-level data parameters used by the example audience metrics estimator of FIGS. 1-2 for purposes of generating census-level estimations of unique audience, impressions, and durations across demographics.

FIG. 8B-8C includes example data sets providing third-party subscriber and census-level data, including total impressions and total duration data used by the example audience metrics estimator of FIGS. 1-2 to generate census-level estimations of unique audience, impressions, and durations across demographics.

FIG. 9 illustrates an example variable characterization based on scale independence and scale invariance, the example audience metrics estimator of FIGS. 1-2 generating estimations of census-level unique audience and impressions, which are independent of scale, and census-level duration, which is invariant to scale.

FIG. 10 is a block diagram of an example processing platform structured to execute the instructions of FIGS. 3-6 to implement the example audience metrics estimator of FIGS. 1-2.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Audience measurement entities (AMEs) perform measurements to determine the number of people (e.g., an audience) who engage in viewing television, listening to radio stations, or browsing websites. Given that companies and/or individuals producing content and/or advertisements want to understand the reach and effectiveness of their content, it is useful to identify such information. To achieve this, companies such as The Nielsen Company, LLC (US), LLC utilize on-device meters (ODMs) to monitor usage of cellphones, tablets (e.g., iPads™) and/or other computing devices (e.g., PDAs, laptop computers, etc.) of individuals who volunteer to be part of a panel (e.g., panelists). Panelists are users who have provided demographic information at the time of registration into a panel, allowing their demographic information to be linked to the media they choose to listen to or view. As a result, the panelists (e.g., the audience) represent a statistically significant sample of the large population (e.g., the census) of media consumers, allowing broadcasting companies and advertisers to better understand who is utilizing their media content and maximize revenue potential.

An on-device meter (ODM) can be implemented by software that collects data of interest concerning usage of the monitored device. The ODM can collect data indicating media access activities (e.g., website names, dates/times of access, page views, duration of access, clickstream data and/or other media identifying information (e.g., webpage content, advertisements, etc.)) to which a panelist is exposed. This data is uploaded, periodically or aperiodically, to a data collection facility (e.g., the audience measurement entity server). Given that a panelist submits their demographic data when registering with an AME, ODM data is advantageous in that it links this demographic information and the activity data collected by the ODM. Such monitoring activities are performed by tagging Internet media to be tracked with monitoring instructions, such as based on examples disclosed in Blumenau, U.S. Pat. No. 6,108,637, which is hereby incorporated herein by reference in its entirety. Monitoring instructions form a media impression request that prompts monitoring data to be sent from the ODM client to a monitoring entity (e.g., an AME such as The Nielsen Company, LLC) for purposes of compiling accurate usage statistics. Impression requests are executed whenever a user accesses media (e.g., from a server, from a cache). When a media user is also a part of the AME's panel (e.g., a panelist), the AME is able to match panelist demographics (e.g., age, occupation, etc.) to the panelist's media usage data (e.g., user-based impression count, user-based impression duration). As used herein, an impression is defined to be an event in which a home or individual accesses and/or is exposed to media (e.g., an advertisement, content in the form of a page view or a video view, a group of advertisements and/or a collection of content, etc.).

Database proprietors operating on the Internet (e.g., Facebook, Google, YouTube, etc.) provide services (e.g., social networking, streaming media, etc.) to registered subscribers. By setting cookies and/or other device/user identifiers, database proprietors can recognize their subscribers when the subscribers use the designated services. Examples disclosed in Mainak et al., U.S. Pat. No. 8,370,489, which is incorporated herein in its entirety, permit AMEs to partner with database proprietors to collect more extensive Internet usage data by sending an impression request to a database proprietor after receiving an initial impression request from a user (e.g., as a result of viewing an advertisement). Since the user may be a non-panelist (e.g., not a member of an AME panel with available associated demographics data), the AME can obtain data from the database proprietor corresponding to subscribers, given that the database proprietor logs/records a database proprietor demographic impression for the user if the given user is a subscriber. However, to protect the privacy of their subscribers, database proprietors generalize subscriber-level audience metrics by aggregating data. The AME therefore has access to third-party aggregate subscriber-based audience metrics where impression counts and unique audience sizes are reported by demographic category (e.g., females 15-20, males 15-20, females 21-26, males 21-26, etc.).

As used herein, a unique audience size is based on audience members distinguishable from one another, such that a single audience member/subscriber exposed a multiple number of times to the same media is identified as a single unique audience member. As used herein, a universe audience (e.g., a total audience) for media is a total number of persons that accessed the media in a particular geographic scope of interest and/or during a time of interest relating to media audience metrics. Determining if a larger unique audience is reached by certain media (e.g., an advertisement) can be used to identify if an AME client (e.g., an advertiser) is reaching a larger audience base. When an AME logs an impression for access to media by a user not associated with any demographic information, the logged impression counts as a census-level impression. As such, multiple census-level impressions can be logged for the same user since the user is not identified as a unique audience member. Estimation of census-level unique audience, impression counts (e.g., number of times a webpage has been viewed), and impression durations for individual demographics can increase the accuracy of usage statistics provided by monitoring entities such as AMEs.

In some examples, for census-level information, an AME has access to the total impression counts (e.g., total number of times a webpage was viewed) and total duration of impressions (e.g., length of time the webpage was viewed), but not the total unique audience (e.g., total number of distinguishable users). The AME can receive additional third-party data limited to users who subscribe to services provided by the third-party, for example, a database proprietor. For example, whereas census-level data includes total impression count and total impression duration for individuals whose demographic information may not be available, the third-party level data includes subscriber-level data for audience size, impression counts, and impression durations that are tied to particular demographics (e.g., demographic-level data). As such, third-party data can provide the AME with partial audience, impression count, and impression duration information down to an aggregate demographic level based on matching of subscriber data to different demographic categories as performed by the database proprietor providing the third-party data. However, in the interest of subscriber privacy, third-party data does not provide audience, impression counts, and durations of impressions tied to a particular subscriber. Example methods, systems and apparatus disclosed herein allow estimation of census-level audience size, impression counts, and impression durations across different demographic categories based on third-party subscriber data that provides audience size, impression counts, and impression durations across the different demographic categories for a subset of the population universe.

Examples disclosed herein use two variables (e.g., number of impressions and impression duration in the census-level and subscriber-based database per individual) that are solved independent of the actual number of available demographics. Examples disclosed herein utilize third-party subscriber-level audience metrics that provide partial information on impression counts, impression duration, and unique audience sizes to overcome the anonymity of census-level impressions when estimating total unique audience sizes for media. Examples disclosed herein apply information theory to derive a solution to parse census-level information into demographics-based data. In examples disclosed herein, a census-level audience metrics estimator determines census-level unique audience, impression counts, and impression durations across demographics by determining probabilities of an individual in a given demographic being a member of the third-party subscriber data for each of the audience size, impression count, and impression duration, determining a probability divergence between the third-party subscriber data and census-level data, and establishing a search space within bounds based on equality constraints that are defined by the summation of the census-level impression counts per demographic being equal to the total reference census-level impression count, and the summation of the census-level impression duration for each demographic being equal to the total reference census-level impression duration. The examples disclosed herein permit estimations that are logically consistent with all constraints, scale independence and invariance.

While examples disclosed herein are described in connection with website media exposure monitoring, disclosed techniques may also be used in connection with monitoring of other types of media exposure not limited to websites. Examples disclosed herein may be used to monitor for media impressions of any one or more media types (e.g., video, audio, a webpage, an image, text, etc.). Furthermore, examples disclosed herein can be used for applications other than audience monitoring (e.g., determining population size, number of attendees, number of observations, etc.). While the disclosed examples include data sets pertaining to impression counts and/or audiences, the data sets can also include data derived from other sources (e.g., monetary transactions, medical data, etc.).

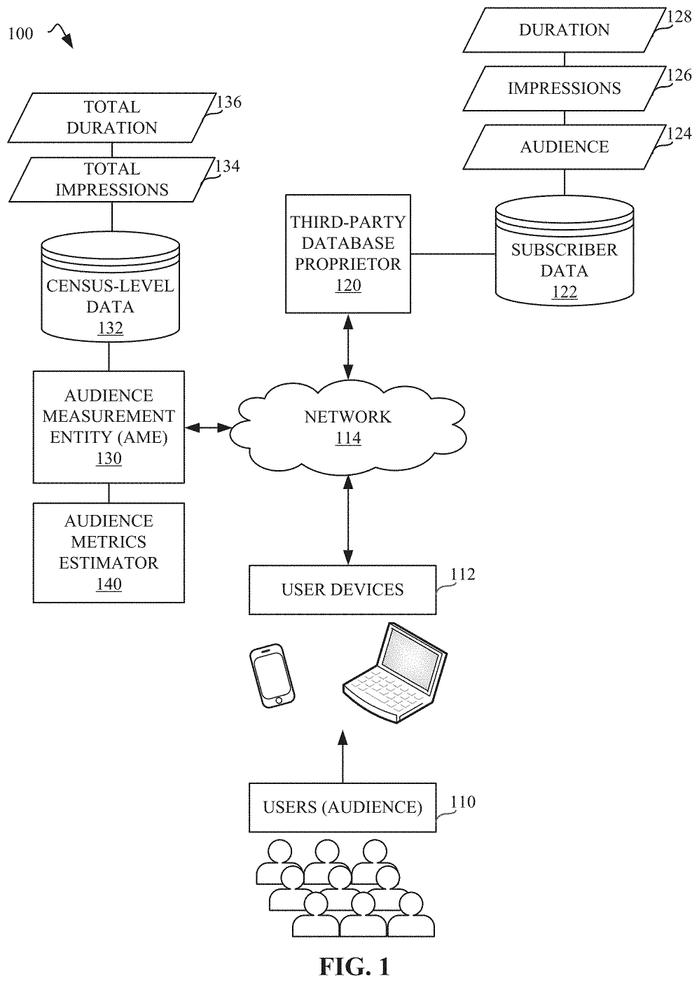

FIG. 1 is a block diagram illustrating an example operating environment 100 in which an audience metrics estimator is implemented to determine census-level audience, impressions, and impression durations across demographics. The example operating environment 100 of FIG. 1 includes example users 110 (e.g., an audience), example user devices 112, an example network 114, an example third-party database proprietor 120, and an example audience measurement entity (AME) 130. The third-party database proprietor 120 includes an example subscriber database 122. The subscriber database 122 includes example subscriber audience size data 124, example impression data 126, and example impression duration data 128. The AME 130 includes example census-level data 132 and an example audience metrics estimator 140. The census-level data 132 includes example total impression counts 134 (e.g., total impressions) and example total impression duration 136 (e.g., total duration).

Users 110 include any individuals who access media on one or more user device(s) 112, such that the occurrence of access and/or exposure to media creates a media impression (e.g., viewing of an advertisement, a movie, a web page banner, a webpage, etc.). The example users 110 can include panelists that have provided their demographic information when registering with the example AME 130. When the example users 110 who are panelists utilize example user devices 112 to access media content through the example network 114, the AME 130 (e.g., AME servers) stores panelist activity data associated with their demographic information. The users 110 also include individuals who are not panelists (e.g., not registered with the AME 130). The users 110 include individuals who are subscribers to services provided by the database proprietor 120 and utilize these services via their user device(s) 112.

User devices 112 can be stationary or portable computers, handheld computing devices, smart phones, Internet appliances, and/or any other type of device that may be connected to a network (e.g., the Internet) and capable of presenting media. In the illustrated example of FIG. 1, the client device(s) 102 include a smartphone (e.g., an Apple® iPhone®, a Motorola™ Moto X™, a Nexus 5, an Android™ platform device, etc.) and a laptop computer. However, any other type(s) of device(s) may additionally or alternatively be used such as, for example, a tablet (e.g., an Apple® iPad™, a Motorola™ Xoom™, etc.), a desktop computer, a camera, an Internet compatible television, a smart TV, etc. The user device(s) 112 of FIG. 1 are used to access (e.g., request, receive, render and/or present) online media provided, for example, by a web server. For example, users 110 can execute a web browser on the user device(s) 112 to request streaming media (e.g., via an HTTP request) from a media hosting server. The web server can be any web browser used to provide media content (e.g., YouTube) that is accessed, through the example network 114, by the example users 110 on example user device(s) 112. Network 114 may be implemented using any suitable wired and/or wireless network(s) including, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events.

In some examples, media (also referred to as a media item) is tagged or encoded to include monitoring or tag instructions. The monitoring instructions are computer executable instructions (e.g., Java or any other computer language or script) executed by web browsers accessing media content (e.g., via network 114). Execution of monitoring instructions causes the web browser to send an impression request to the servers of the AME 130 and/or the database proprietor 120. Demographic impressions are logged by the database proprietor 120 when user devices 112 accessing media are identified as belonging to registered subscribers to database proprietor 120 services. The database proprietor 120 stores data generated for registered subscribers in the subscriber data storage 122. Likewise, the AME 130 logs census-level media impressions (e.g., census-level impressions) for user devices 112, regardless of whether demographic information is available for such logged impressions. The AME 130 stores census-level data information in the census-level data storage 132. Further examples of monitoring instructions and methods of collecting impression data are disclosed in U.S. Pat. No. 8,370,489 entitled “Methods and Apparatus to Determine Impressions using Distributed Demographic Information,” U.S. Pat. No. 8,930,701 entitled “Methods and Apparatus to Collect Distributed User Information for Media Impressions and Search Terms,” and U.S. Pat. No. 9,237,138 entitled “Methods and Apparatus to Collect Distributed User Information for Media Impressions and Search Terms,” all of which are hereby incorporated herein by reference in their entireties.

The AME 130 operates as an independent party to measure and/or verify audience measurement information relating to media accessed by subscribers of the database proprietor 120. When media is accessed by users 112, the AME 130 stores census-level information in the census-level data storage 132, including total impression counts 134 (e.g., number of webpage views), and total impression durations 136 (e.g., length of time that a webpage was viewed). The third-party database proprietor 120 provides the AME 130 with aggregate subscriber data that obfuscates the person-specific data, such that reference aggregates among the individuals within a demographic are available (e.g., third-party aggregate subscriber-based audience metrics). For example, the subscriber audience data 124, the impression counts data 126, and impression durations data 128 are provided at a demographic level (e.g., females 15-20, males 15-20, females 21-26, males 21-26, etc.). For example, the subscriber audience data 124 corresponds to unique audience size data in the aggregate per demographic category.

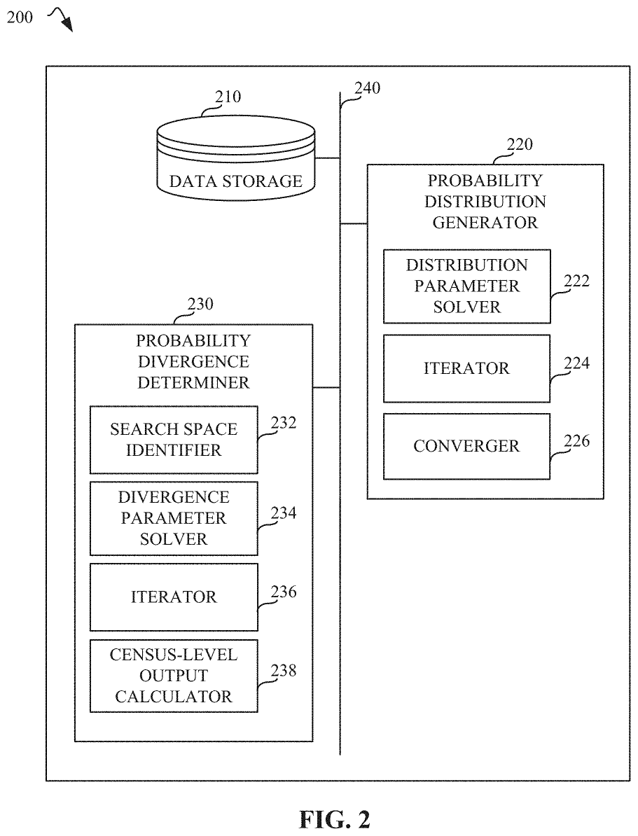

The audience metrics estimator 140 of the AME 130 receives third-party aggregate subscriber-based audience metrics data (e.g., audience size data 124, impression counts data 126, and impression duration data 128). The audience metrics estimator 140 uses the aggregate data to estimate census-level audience size data, census-level impression counts data, and census-level impression duration data. In addition, the audience metrics estimator 140 uses the census-level data available to the AME 130 (e.g., total impression counts 134 and total impression durations 136) to make the census-level audience, impressions, and duration estimates for the subscriber-based data, as further described below in connection with FIG. 2.

FIG. 2 is a block diagram of an example implementation of the audience metrics estimator 140 of FIG. 1. The example audience metrics estimator 140 includes an example data storage 210, an example probability distribution generator 220, and an example probability divergence determiner 230, all of which are connected using an example bus 240.

The data storage 210 stores third-party aggregate subscriber-based audience metrics data retrieved from the third-party database proprietor 120. For example, data retrieved from the third-party database proprietor 120 and stored in the data storage 210 can include subscriber data 122 (e.g., third-party audience size 124, third-party impression counts 126, and third-party impression duration 128). The data storage 210 can also store census-level data 132 (e.g., total impressions 134 and total impression durations 136). The audience metrics estimator 140 can retrieve the third-party and census-level data from the data storage 210 to perform census-level estimation calculations (e.g., determine census-level unique audience size, census-level impression counts, and census-level impression durations for a given demographic). The data storage 210 may be implemented by any storage device and/or storage disc for storing data such as, for example, flash memory, magnetic media, optical media, etc. Furthermore, the data stored in the data storage 210 may be in any data format such as, for example, binary data, comma delimited data, tab delimited data, structured query language (SQL) structures, etc. While in the illustrated example the data storage 210 is illustrated as a single database, the data storage 210 can be implemented by any number and/or type(s) of databases.

The probability distribution generator 220 generates a single estimate of the probability distribution for any individual within a given population, such that the distribution is subject to a probability of the individual being in the audience, having an average number impressions (e.g., page views), and having an average impression duration.

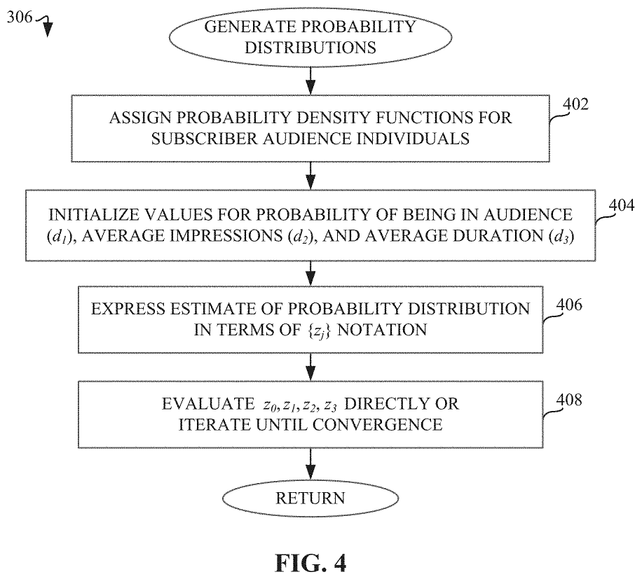

The distribution parameter solver 222 solves for parameters associated with the probability distributions for each individual of a given population. The distribution parameter solver 222 can use the iterator 224 and the converger 226 to determine the final probability distribution parameters based on whether the parameters can be solved for directly or require the use of an iterator to converge to the final solution. For example, the probability distribution generator 220 assigns probability density functions, marginal probabilities, and/or person-specific probability distributions to third-party subscriber-based audience individuals. In some examples, probability density functions are assigned to subscriber audience individuals using data for third-party subscriber impressions 126 and impression durations 128, using a marginal probability of having a number of impressions (n) independent of the impression duration (t). In some examples, the probability distribution generator 220 assigns person-specific probability distributions for individuals within a demographic (k) based on the probability of the individual being in an audience, having an average impression count, and having an average impression duration, as described in more detail in association with FIG. 4. For example, the distribution parameter solver 222 uses the iterator 224 to perform fixed-point iteration to solve for variables that are otherwise not solved directly. In some examples, the distribution parameter 222 solver uses a converger 226 to converge to the solution of individual probability distribution estimates, as described in more detail in association with FIG. 4. In some examples, the iterator 224 may use a first order approximation for an initial starting value as part of estimating a solution to the probability distribution estimate.

The probability divergence determiner 230 uses an example search space identifier 232, an example divergence parameter solver 234, an example iterator 236, and an example census-level output calculator 238 to determine census-level audience, page views, and durations across demographics.

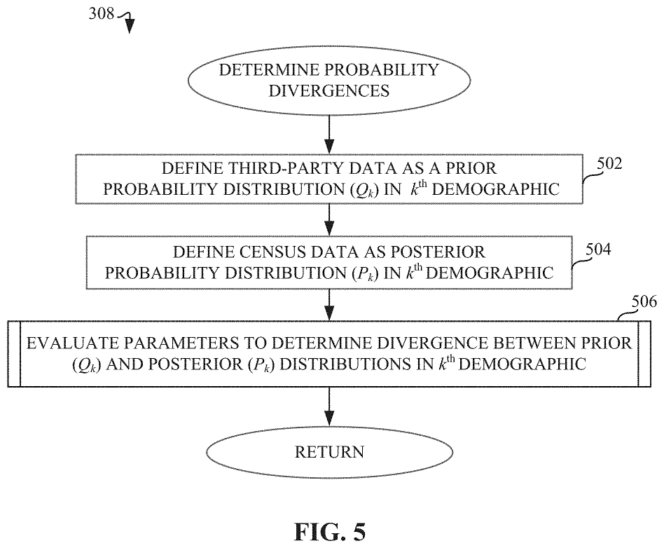

The probability divergence determiner 230 can be used to determine probability divergences between prior and posterior distributions in a given demographic using available third-party subscriber data 122 and census-level data 132 of FIG. 1. For example, the probability divergence determiner 230 can define third-party data as a prior probability distribution in the k^{th} demographic and define the census-level data as a posterior probability distribution in the k^{th} demographic, as described in more detail below in association with FIG. 5. In some examples, the probability divergence can be determined using a Kullback-Leibler (KL) divergence between the two distributions.

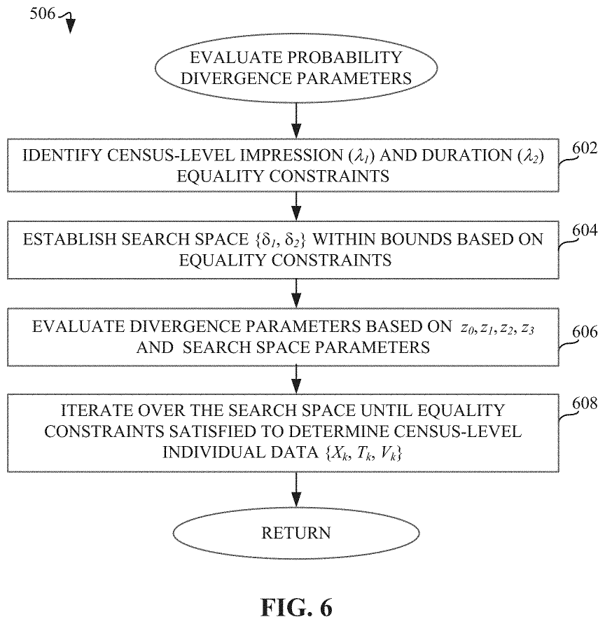

To yield the solutions to census-level audience, impression counts, and impression durations for different demographic categories based on the probability divergence, the probability divergence determiner 230 uses the search space identifier 232 to establish a search space within a given set of bounds based on census-level impression and duration equality constraints. For example, once the equality constraints are established, the divergence parameter solver 234 can evaluate the divergence parameters based on the equality constraints. In some examples, the divergence parameter solver 234 uses the iterator 236 to iterate over the search space determined by the search space identifier 232 until the equality constraints are satisfied (e.g., the equality constraints defined by the summation of the census-level impression counts per demographic being equal to the total reference census-level impression count, and the summation of the census-level impression duration for each demographic being equal to the total reference census-level impression duration). The census-level output calculator 238 estimates census-level individual data (e.g., audience, impressions, and duration) based on solutions that satisfy the above equality constraints, as described in more detail in association with FIG. 6.

While an example manner of implementing the audience metrics estimator 140 is illustrated in FIGS. 1 and 2, one or more of the elements, processes and/or devices illustrated in FIGS. 1 and 2 may be combined, divided, re-arranged, omitted, eliminated and/or implemented in any other way. Further, the example data storage 210, the probability distribution generator 202, the probability divergence determiner 230 and/or, more generically, the example audience metrics estimator 140 of FIGS. 1-2 may be implemented by hardware, software, firmware and/or any combination of hardware, software and/or firmware. Thus, for example, any of the example data storage 210, the example probability distribution generator 220, the example probability divergence determiner 230, and/or, more generically, the example audience metrics estimator 140 of FIGS. 1-2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data storage 210, the example probability distribution generator 220, and/or the example probability divergence determiner 230 is/are hereby expressly defined to include a non-transitory computer readable storage device or storage disk such as a memory, a digital versatile disk (DVD), a compact disk (CD), a Blu-ray disk, etc. including the software and/or firmware. Further still, the example audience metrics estimator 140 may include one or more elements, processes and/or devices in addition to, or instead of, those illustrated in FIGS. 1 and 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

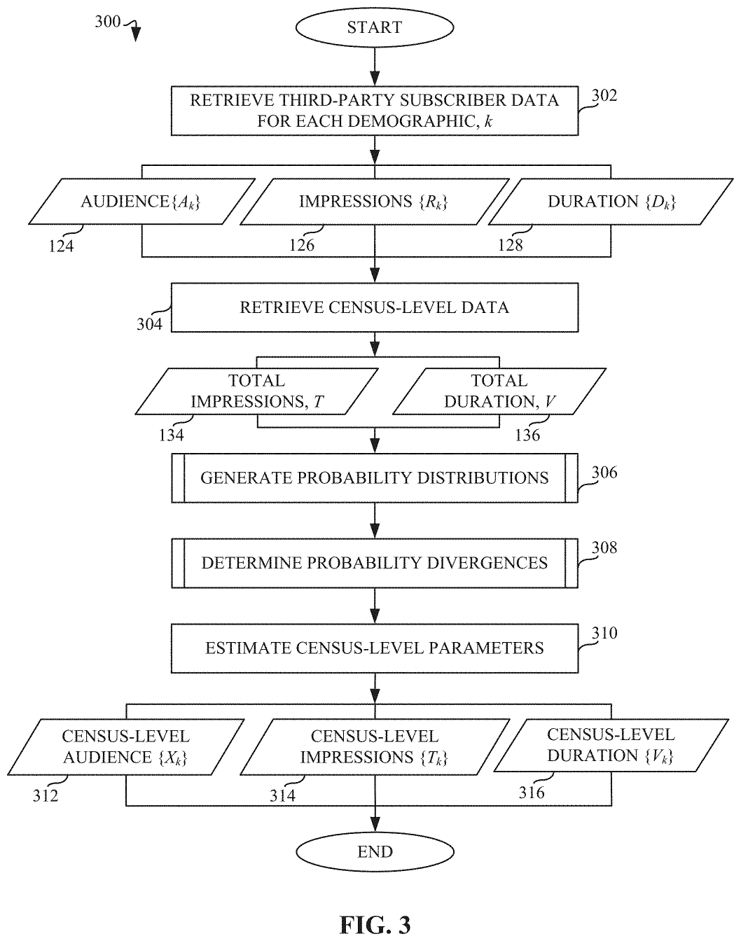

Flowcharts representative of example machine readable instructions for implementing the example audience metrics estimator 140 of FIGS. 1-2 are shown in FIGS. 3-6, respectively. The machine-readable instructions may be one or more executable programs or portion(s) of an executable program for execution by a processor such as the processor 906 shown in the example processor platform 900 discussed below in connection with FIGS. 3-6. The program may be embodied in software stored on a non-transitory computer readable storage medium such as a CD-ROM, a floppy disk, a hard drive, a digital versatile disk (DVD), a Blu-ray disk, or a memory associated with the processor 906, but the entire program and/or parts thereof could alternatively be executed by a device other than the processor 906 and/or embodied in firmware or dedicated hardware. Further, although the example program is described with reference to the flowcharts illustrated in FIGS. 3-6, many other methods of implementing the example audience metrics estimator 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 3, 4, 5 and/or 6 may be implemented using executable instructions (e.g., computer and/or machine readable instructions) stored on a non-transitory computer and/or machine readable medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart 300 representative of machine readable instructions which may be executed to implement elements of the example audience metrics estimator 140 of FIG. 2. The example audience metrics estimator 140 retrieves third-party subscriber data (e.g., available from the database proprietor 120 of FIG. 1) for each demographic (k) from the data storage 202 of FIG. 2 (block 302). The third-party database proprietor 120 determines audience size, impression count, and impression duration data for different demographic categories of subscribers based on subscriber data 122 collected when a subscriber is exposed to impressions (e.g., third-party media) on user devices 112. For example, a logged impression 126 is associated with a specific subscriber (e.g., users 110), and a specific duration 128 of the logged impression. Based on this data, the audience metrics estimator 140 can retrieve inputs of subscriber-based audience size {Aₖ} data (e.g., audience size data 124), impression counts {Rₖ} data (e.g., impression counts data 126), and impression duration {Dₖ} data (e.g. impression duration data 128) for different aggregate demographic categories. The example audience metrics estimator 140 also retrieves census-level data from the census-level data storage 132 of the AME 130 (block 304). For example, the AME 130 can also access logged impressions that are made by users 110 when using devices 112, but the data is not associated with specific demographics of the users when such users are not members of an AME panel, such that the AME 130 can determine the total logged impressions 134 (e.g., total number of census-level impressions by users 110) and corresponding total census-level impression durations 136, while not differentiating between individual users. As such, the census-level data storage 132 provides inputs to the audience metrics estimator 140 of total census-level impressions (T) data (e.g., total impressions data 134) and total census-level duration (T) data (e.g., total duration data 136). Using the third-party and census-level data, the example probability distribution generator 220 of the example audience metrics estimator 140 determines the probability of an individual in a given demographic k being a member of the third-party subscriber data (e.g., audience size {Aₖ} data, impression counts {Rₖ} data, and impression duration {Dₖ} data), and generates a probability distribution for each individual within the total population subject to these constraints, such that the distribution parameter solver 222 determines the distribution parameters that can be further used to identify potential solutions for census-level audience, impressions, and durations data. (block 306). Once the probability distributions have been generated, the example probability divergence determiner 230 of FIG. 2 determines probability divergences between the third-party and census-level data (block 308). Furthermore, the example probability divergence determiner 230 estimates census-level individual data (e.g., unique audience size, impressions, and durations) using the census-level output calculator 238 based on the probability distribution parameters calculated using the distribution parameter solver 222 and the probability divergence parameters calculated using the divergence parameter solver 234 (block 310). The example audience metrics estimator 140 provides census-level outputs, including output estimates for census-level audience size {Xₖ} (block 312), census-level impression counts {Tₖ} (block 314), and census-level impression duration {Vₖ} (block 316). As such, using census-level data (e.g., total impressions 134 and total duration 136) and third-party data (e.g., audience size 124, impression counts 125, and duration 128), the audience metrics estimator 140 estimates the census-level unique audience 312, impressions 314, and duration 316 for individual demographic categories.

FIG. 4 is a flowchart 306 representative of machine readable instructions which may be executed to implement elements of the example audience metrics estimator 140 of FIG. 2 to generate probability distributions. For example, the probability distribution generator 220 assigns probability density functions [p_{n,t}⁽ⁱ⁾] for panel audience individuals (i) using impression counts (n) and impression durations (t) (block 402). Each person has a fixed, but unknown, number of impressions (n) and time of impression duration (t), both in the census-level and third-party database (e.g., ‘John Smith’ viewed a webpage 5 times, totaling 20 minutes, of which only 3 views and 10 minutes were registered in a database, or none at all). However, aggregate information obfuscates the person-specific data and leaves a reference aggregate among the individuals within a demographic, such that the uncertainty for each person can be expressed in the form of a probability distribution. Such a distribution is a mixture of a point mass distribution and a bivariate distribution-continuous in one dimension and discrete in the other dimension. The point mass distribution is at n=0, indicating that the individual did not view any pages, thereby resulting in no duration. The bivariate distribution portion (p_{n,t}) is discrete along n {1, . . . , ∞} and continuous along the open interval t∈(0,∞). For example, parallel sheets of continuous curves, each curve spaced at each value of n, provide a visual representation of these distributions.

For purposes of deriving the solution to individual probability distribution estimates using the example probability distribution generator 220, an assumption is made that there are a total of U individuals in the total population. The uncertainty with a collection of U probability distributions going across the possibility of each individual having any impression counts (n) and any impression durations (t), along with not having any impressions, can be expressed using the domain of n={1, . . . , ∞} and t∈(0,∞), respectively, for each person, such that, for example, if U=5, persons 1-5 are assigned probabilities as follows: [p₀⁽¹⁾, p_{n,t}⁽¹⁾], [p₀⁽²⁾, p_{n,t}⁽²⁾], [p₀⁽³⁾, p_{n,t}⁽³⁾], [p₀⁽⁴⁾, p_{n,t}⁽⁴⁾], and [p₀⁽⁵⁾, p_{n,t}⁽⁵⁾]. The probability distribution generator 220 assigns p₀⁽ⁱ⁾ as the probability that the i^{th} person did not have any impression counts (e.g., point mass distribution), and assigns p_{n,t}⁽ⁱ⁾ as the probability density function that represents the probabilities that the ith person has n impressions with a duration t, where the duration t corresponds to the total duration for the n impressions. In some examples, the continuous portion, for given numbers of impressions n of webpage views, can be a distribution of duration of the average video per webpage view, thereby representing an average impression duration per impression count. Since the only census-level aggregate information available is total impression counts (e.g., total impressions 134) and total impression durations (e.g., total duration 136), the average duration per a webpage view is considered to be constant. For example, users who register one webpage view are more likely to watch longer videos than users who watch 100 webpage views. While users with a record of 100 webpage views can have video views that are shorter compared to users with 1 webpage view only, their total duration is assumed to be equal (e.g., 1 view×10 minute average per view=5 views×2 minute average per view=10 minute duration). Based on this information, the probability distribution generator 220 assigns a marginal probability of having n impressions independent of the impression duration t. The marginal probability of a user having n impression counts (e.g., n webpage views), independent of the duration of these impressions, can be expressed in accordance with Equation 1 below:

Pr(n)=∫₀^{∞}p_{n,t}⁽ⁱ⁾dt Equation 1

The total probability for each individual can be further expressed in accordance with Equation 2 below, such that the combination of all probabilities associated with an individual is constrained to a total of 1:

p₀⁽ⁱ⁾+Σₙ₌₁^{∞}∫₀^{∞}p_{n,t}⁽ⁱ⁾dt=1 Equation 2

In examples in which no information on individual behavior is available, each individual within a given demographic is assigned the same probability distribution. For example, if 100 individuals have a total of 300 impression counts (e.g., page views), with a total duration of 600 minutes, each person has, on average, a total of 3 impression counts with a total duration of 6 minutes, with each impression count having an average duration of 2 minutes.

Given that the audience metrics estimator 140 has access to third-party subscriber information (e.g., audience data 124, impression count data 126, and duration data 128), a person-specific distribution can be generated (e.g., by dividing the data amongst the individuals within a demographic) in accordance with Equations 3-7 below:

$$\begin{matrix}{maximize}_{P} H = ( - {p}_{0} log ( {p}_{0} ) ) + {\sum }_{n = 1}^{∞} ( - {\int }_{0}^{∞} {p}_{n , t} log ( {p}_{n , t} ) dt ) & Equation 3 \\ subject to {p}_{0} + {\sum }_{n = 1}^{∞} {\int }_{0}^{∞} {p}_{n , t} dt = {d}_{0} = 1 & Equation 4 \\ {\sum }_{n = 1}^{∞} {\int }_{0}^{∞} {p}_{n , t} dt = {d}_{1} & Equation 5 \\ {\sum }_{n = 1}^{∞} n {\int }_{0}^{∞} {p}_{n , t} dt = {d}_{2} & Equation 6 \\ {\sum }_{n = 1}^{∞} n {\int }_{0}^{∞} {tp}_{n , t} dt = {d}_{3} & Equation 7\end{matrix}$$

The probability distribution generator 220 assigns the person-specific distribution (H) of Equation 3, which provides an estimate of the distribution for any individual within the population, subject to the constraints of Equations 4-7. Equation 4 represents the constraint that the estimated probability distribution for a given individual totals to 1 (explained in connection with Equations 1-2 above). Equation 5 is a constraint governing the probability of an individual being in the audience (e.g., having at least one impression) (d₁). Equation 6 is a constraint governing the average impression count (d₂) for an individual. Equation 7 is a constraint governing the average impression duration (d₃) for an individual. The probability distribution generator 220 thereby assigns and initializes values for a person-specific probability distribution (H) for individuals within a demographic based on the presented constraints of Equations 4-7 (block 404). The probability distribution generator 220 can re-arrange the solution to the person-specific distribution problem of Equations 3-7 (e.g., express in terms of z notation) in accordance with Equations 9-12, subject to the final solution for the set of {zⱼ} expressed in accordance with Equation 8 (block 406):

$$\begin{matrix}{p}_{t} = \{ \begin{matrix}{z}_{0} t = 0 \\ {z}_{0} {z}_{1} {z}_{2}^{n} {z}_{3}^{n t} t > 0\end{matrix} & Equation 8 \\ {p}_{0} + {\sum }_{n = 1}^{∞} {\int }_{0}^{∞} {P}_{n , t} dt = {z}_{0} + {\sum }_{n = 1}^{∞} {\int }_{0}^{∞} {z}_{0} {z}_{1} {z}_{2}^{n} {z}_{3}^{n t} d t = {z}_{0} + \frac{{z}_{0} {z}_{1} log ( 1 - {z}_{2} )}{log ( {z}_{3} )} = 1 & Equation 9 \\ {\sum }_{n = 1}^{∞} {\int }_{0}^{∞} {p}_{n , t} d t = {\sum }_{n = 1}^{∞} {\int }_{0}^{∞} {z}_{0} {z}_{1} {z}_{2}^{n} {z}_{3}^{n t} dt = \frac{{z}_{0} {z}_{1} log ( 1 - {z}_{2} )}{log ( {z}_{3} )} = {d}_{1} & Equation 10 \\ {\sum }_{n = 1}^{∞} n {\int }_{0}^{∞} {p}_{n , t} dt = {\sum }_{n = 1}^{∞} n {\int }_{0}^{∞} {z}_{0} {z}_{1} {z}_{2}^{n} {z}_{3}^{n t} dt = \frac{- {z}_{0} {z}_{1} {z}_{2}}{( 1 - {z}_{2} ) log ( {z}_{3} )} = {d}_{2} & Equation 11 \\ {\sum }_{n = 1}^{∞} n {\int }_{0}^{∞} t {p}_{n , t} d t = {\sum }_{n = 1}^{∞} n {\int }_{0}^{∞} {tz}_{0} {z}_{1} {z}_{2}^{n} {z}_{3}^{n t} dt = \frac{- {z}_{0} {z}_{1} log ( 1 - {z}_{2} )}{{( log ( {z}_{3} ) )}^{2}} = {d}_{3} & Equation 12\end{matrix}$$

The distribution parameter solver 222 solves for the variables z₀, z₁, z₂, and z₃. In some examples, the distribution parameter solver 222 can solve for z₀ and z₃ directly, while the solution to z₁ is obtained directly based on the solution to z₂, which can be solved using, for example, fixed-point iteration with the iterator 224 (block 408). For example, the direct solutions to z₀ and z₃ are represented below by Equations 13 and 14, respectively. The solution to z₂ can be represented in terms of Equation 15, such that the solution to z₁ is based on the solution to z₂, as shown in Equation 16:

$$\begin{matrix}{z}_{0} = 1 - {d}_{1} & Equation 13 \\ {z}_{3} = exp ( \frac{- {d}_{1}}{{d}_{3}} ) & Equation 14 \\ \frac{- {z}_{2}}{( 1 - {z}_{2} ) log ( 1 - {z}_{2} )} = \frac{{d}_{2}}{{d}_{1}} & Equation 15 \\ {z}_{1} = ( \frac{{d}_{1} {d}_{2}}{( 1 - {d}_{1} ) {d}_{3}} ) ( \frac{1 - {z}_{2}}{{z}_{2}} ) & Equation 16\end{matrix}$$

In the examples presented herein, the iterator 224 applies fixed-point iteration to generate a solution to z₂, such that a unique solution within 0≤z₂≤1 can be identified provided that d₂≥d₁ (e.g., impression counts (d₂) are equal to or surpass the number of individuals in the audience (d₁)). For example, an assumption can be made that at least one audience member has at least one impression count. Iterator 224 generates an expression for z₂ using, for example, fixed-point iteration, consisted with Equation 17. A first order approximation for the initial starting value is shown in Equation 18. The iterator 224 proceeds to iterate based on the initial starting value (e.g., Equation 18), and the converger 2226 is used to converge to a final solution of the individual probability distribution estimate (H):

$$\begin{matrix}{z}_{2} ← 1 + \frac{1}{( \frac{{d}_{2}}{{d}_{1}} ) log ( 1 - {z}_{2} ) - 1} & Equation 17 \\ {z}_{2} \approx \sqrt{1 - \frac{{d}_{1}}{{d}_{2}}} & Equation 18\end{matrix}$$

In some examples, the convergence to the final solution can be accomplished using any method that permits a convergence (e.g., convergence algorithm), and is not limited to the use of a fixed-point iteration described above as an example method of solving for the individual probability distribution estimate (H).

Once a solution to the individual probability distribution estimate is available, an estimate of any probability can be calculated for each individual (e.g., audience member). For example, if among 100 individuals there is an audience of 50 people and 200 impression counts (e.g., page views) with 400 time units of duration, z₀, z₁, z₂, and z₃) can be solved for as shown below in Example 1, based on Equations 13-18:

$${d}_{0} = \frac{100}{100} {z}_{0} = 0.5 \\ {d}_{1} = \frac{50}{100} {z}_{1} = 0.0534951 \\ {d}_{2} = \frac{200}{10 ( )} {z}_{2} = 0.90355 \\ {d}_{3} = \frac{400}{10 ( )} {z}_{3} = 0.882497 \qquad Example 1$$

In this example, the estimate of any probability can be calculated for each individual, such that if p₀=z₀=0.5, there is a 50% chance of the individual having no impression counts with no duration. To estimate the probability of the audience in this example having 3 impression counts (e.g., n=3), the audience metric estimator 140 can apply Equation 1 to generate an estimate, as shown below in Example 2:

Pr(n=3)=∫₀^{∞}p_{3,t}dt≈0.05258 Example 2

The audience metric estimator 140 can also determine the total impression duration given n impression counts as shown in Example 3, where the denominator represents the probability of being in the audience and the numerator represents the average duration of the n impressions:

$$\frac{n {\int }_{0}^{∞} t {p}_{n , t} d t}{{\int }_{0}^{∞} {p}_{n , t} dt} = \frac{{d}_{3}}{{d}_{1}} = 8 \qquad Example 3$$

The expression of Example 3 is independent of the impression count n. For example, the numerator is multiplied by n with a focus on individuals who have i impression counts to yield the total duration given n impression counts. However, the solution is independent of the unknown number of impression counts that an individual is associated with (e.g., based on information presented in Example 1, there are 400 units of duration among 50 individuals, yielding an average of 8 time units).

FIG. 5 is a flowchart 308 representative of machine readable instructions which may be executed to implement elements of the example audience metrics estimator 140 of FIG. 2, the flowchart representative of instructions used to determine probability divergences. Once the audience metrics estimator 140 generates probability distributions using the probability distribution generator 220, as described above in connection with FIG. 4, the probability divergence determiner 230 determines probability divergences. A probability divergence allows for a comparison between two probability distributions. In the examples disclosed herein, the probability divergence permits a comparison between the distribution of third-party subscriber data and the distribution of census-level data. In the examples disclosed herein, a Kullback-Leibler probability divergence (KL divergence) is used to measure the difference between these two probability distributions (e.g., determine how well one probability distribution approximates another probability distribution). For example, the probability divergence determiner 230 defines third-party subscriber data as a prior distribution (Q) and census-level data as a posterior distribution (P). The audience size and impression durations are equally divided across the entire population of individuals in a k^{th} demographic (Uₖ), such that U is representative of a population universe estimate. A universe estimate (e.g., a total audience) can be defined as, for example, the total number of persons that accessed the media in a particular geographic scope of interest and/or during a time of interest relating to media audience metrics. For example, the universe estimate can be based on census-level data 132 obtained by the AME 130 during assessment of logged impressions by user devices 112. For example, the k^{th} demographic can represent a demographic category (e.g., females 35-40, males 35-40, etc.). As such, the probability divergence determiner 230 defines third-party data as a prior probability distribution in the k^{th} demographic (Qₖ) (block 502) and census-level data as a posterior probability distribution in the k^{th} demographic (Pₖ) (block 504) in a manner consistent with Equations 19-22:

$$\begin{matrix}{d}_{0}^{Q} = 1 \\ {d}_{0}^{P} = 1 & Equation 19 \\ {d}_{1}^{Q} = \frac{{A}_{k}}{{U}_{k}} \\ {d}_{1}^{P} = \frac{{X}_{k}}{{U}_{k}} & Equation 20 \\ {d}_{2}^{Q} = \frac{{R}_{k}}{{U}_{k}} \\ {d}_{2}^{P} = \frac{{T}_{k}}{{U}_{k}} & Equation 21 \\ {d}_{3}^{Q} = \frac{{D}_{k}}{{U}_{k}} \\ {d}_{3}^{P} = \frac{{V}_{k}}{{U}_{k}} & Equation 22\end{matrix}$$

In Equations 19-22, the probability that a specific individual in the k^{th} demographic is a member of the third-party aggregated subscriber audience total (Aₖ) is defined as Aₖ/Uₖ, the probability that a specific individual in the k^{th} demographic has impression counts in the third-party aggregated subscriber impression count total (Rₖ) is defined as Rₖ/Uₖ, and the probability that a specific individual in the k^{th} demographic has an impression duration in the third-party aggregated impression duration total (Dₖ) is defined as Dₖ/Uₖ. In the examples disclosed herein, the audience metrics estimator 140 accesses third-party data (e.g., subscriber data 122 of FIG. 1), which provides anonymized aggregate data for subscriber audience (Aₖ), impression counts (Rₖ), and impression durations (Dₖ) (e.g., audience 124, impressions 126, and duration 128 data, respectively, of FIG. 1). However, for census-level data, the audience metric estimator 140 only has access to census-level total impression counts 134 and total impression durations 136. In Equations 19-22, the probability that a specific individual in the k^{th} demographic is a member of the census-level unique audience total (Xₖ) is defined as Xₖ/Uₖ, the probability that a specific individual in the k^{th} demographic has impression counts in the census-level impression count total (Tₖ) is defined as Tₖ/Uₖ, and the probability that a specific individual in the k^{th} demographic has an impression duration in the census-level impression duration total (Vₖ) is defined as Vₖ/Uₖ. Once the probability divergence determiner 230 has defined the prior and posterior distributions for the third-party subscriber data and the census-level data (blocks 502 and 504), respectively, the divergence parameter solver 234 determines divergences between prior and posterior distributions in the 0 demographic in order to find solutions for the census-level unique audience, impression counts, and impression duration (block 506), as detailed below in connection with FIG. 6.

FIG. 6 is a flowchart 506 representative of machine readable instructions which may be executed to implement elements of the example audience metrics estimator 140 of FIG. 2, the flowchart representative of instructions used to determine probability divergences of FIG. 5. Except for having different values, the prior (Qₖ) and posterior (Pₖ) distributions are in the same domain and have the same linear constraints. Therefore, the divergence parameter solver 234 defines the divergence (e.g., Kullback-Leibler divergence KL(Pₖ:Qₖ), where Pₖ is a posterior probability distribution defining census-level data and Qₖ is a prior probability distribution defining third-party subscriber data) of an individual from third-party subscriber data to census-level data in accordance with Equation 23:

$$K L ( {P}_{k} : {Q}_{k} ) = {\sum }_{j = 0}^{m} {d}_{j}^{P} log ( \frac{{z}_{j}^{P}}{{z}_{j}^{Q}} ) \qquad Equation 23$$

In Equation 23, the divergence parameter solver 234 expresses the KL divergence in terms of z notation, referring to the solutions to z₀, z₁, z₂, and z₃ determined in Equations 13-16 as previously described, and reproduced below as Equations 24-27:

$$\begin{matrix}{z}_{0} = 1 - {d}_{1} & Equatio n 24 \\ {z}_{1} = ( \frac{{d}_{1} {d}_{2}}{( 1 - {d}_{1} ) {d}_{3}} ) ( \frac{1 - {z}_{2}}{{z}_{2}} ) & Equation 25 \\ \frac{- {z}_{2}}{( 1 - {z}_{2} ) log ( 1 - {z}_{2} )} = \frac{{d}_{2}}{{d}_{1}} & Equation 26 \\ {z}_{3} = exp ( \frac{- {d}_{1}}{{d}_{3}} ) & Equation 27\end{matrix}$$

In some examples, the divergence parameter solver 234 expands Equation 23 to yield a description of how any specific individual's distribution within the k^{th} demographic can change, in accordance with Equation 28:

$$\begin{matrix}K L ( {P}_{k} \text{:} {Q}_{k} ) = {\sum }_{j = 0}^{m} {d}_{j}^{P} log ( \frac{{z}_{j}^{P}}{{z}_{J}^{Q}} ) \\ = {\sum }_{j = 0}^{m} {d}_{j}^{P} [ log ( {z}_{j}^{P} ) - log ( {z}_{j}^{Q} ) ] \\ = ( {d}_{0}^{P} ) [ log ( {z}_{0}^{P} ) - log ( {z}_{0}^{Q} ) ] … + \\ ( {d}_{1}^{P} ) [ log ( {z}_{1}^{P} ) - log ( {z}_{1}^{Q} ) ] … + \\ ( {d}_{2}^{P} ) [ log ( {z}_{2}^{P} ) - log ( {z}_{2}^{Q} ) ] … + \\ ( {d}_{3}^{P} ) [ log ( {z}_{3}^{P} ) - log ( {z}_{3}^{Q} ) ] \end{matrix} \qquad Equation 28$$

Given that all individuals in a k^{th} demographic are assumed to have the same behavior, the divergence parameter solver 234 multiplies KL(Pₖ: Qₖ) by the number of individuals in the k^{th} demographic (Uₖ) to determine how the individuals within a demographic can change collectively (e.g., since the divergences are the same, multiplication is used instead of adding the KL-divergence of each individually together). To determine the total divergence across the population, the divergence parameter solver 234 sums across all divergences and across all demographics, in accordance with Equation 29 (block 604):

KL(P:Q)=Σₖ₌₁^{K}Uₖ(KL(Pₖ:Qₖ)) Equation 29

To fully describe the behavior of audiences and durations, the divergence parameter solver 234 minimizes Equation 29 in accordance with Equation 30:

$${minimize}_{\{ {X}_{k} \} , \{ {T}_{k} \} , \{ {V}_{k} \}} KL ( P \text{:} Q ) = {\sum }_{k = 1}^{K} {U}_{k} ( KL ( {P}_{k} \text{:} {Q}_{k} ) ) \\ subject to {\sum }_{k = 1}^{K} {T}_{k} = T \\ {\sum }_{k = 1}^{K} {V}_{k} = V \qquad Equation 30$$

In Equation 30, (Xₖ), (Tₖ), and (Vₖ) represent census-level data pertaining to unique audience size, impression counts, and impression duration, respectively, all of which are unknown. However, Equation 30 is subject to reference values of the total census-level impression counts (7) and the total reference census-level impression duration (V) (e.g., total impressions 134 and total duration 136). In some examples, the divergence parameter solver 234 solves the system of Equation 30 by taking a Lagrangian ( [symbol] ) of the system in accordance with Equations 31-34, where the solution is for all (∀) demographics k={1, 2, . . . , K}, in addition to setting the partial derivative with respect to the Lagrange multipliers (λ₁ and λ₂) equal to 0 (e.g., Equation 35):

$$\begin{matrix}ℒ = KL ( P \text{:} Q ) - {λ}_{1} ( {\sum }_{k = 1}^{K} {T}_{k} - T ) - {λ}_{2} ( {\sum }_{k = 1}^{K} {V}_{k} - V ) & Equation 31 \\ \frac{\partial ℒ}{\partial {X}_{k}} = 0 \\ ∀ k = \{ 1 , 2 , … , K \} & Equation 32 \\ \frac{\partial ℒ}{\partial {T}_{k}} = 0 \\ ∀ k = \{ 1 , 2 , … , K \} & Equation 33 \\ \frac{\partial ℒ}{\partial {V}_{k}} = 0 \\ ∀ k = \{ 1 , 2 , … , K \} & Equation 34 \\ \frac{\partial ℒ}{\partial {λ}_{1}} = 0 \\ \frac{\partial ℒ}{\partial {λ}_{2}} = 0 & Equation 35\end{matrix}$$

The divergence parameter solver 234 solves the Lagrangian of Equation 31 using the Lagrange multipliers (λ₁ and λ₂) to represent the census-level impression count constraint (λ₁), included within the reference census-level data for total census-level impression counts (T), and the census-level impression duration constraint (λ₂), included within the total reference census-level impression duration (V). Other than the constraints of total impression counts (λ₁) and total impression durations (λ₂) across demographics (k), each demographic is mutually exclusive and does not impact the other demographics. Therefore, besides that addition of the constraints noted above, the Lagrangian-based ( [symbol] ) derivative of census-level unique audience size {Xₖ}, impression counts {Tₖ}, and impression duration {Vₖ} involve terms of the same demographic (e.g., females 35-40 years of age).

The search space identifier 232 establishes a search space {δ₁, δ₂} within bounds based on the census-level impression (λ₁) and census-level duration (λ₂) equality constraints (blocks 602, 604). For example, the search space {δ₁, δ₂} can be defined in accordance with

$$\begin{matrix}1 \leq {δ}_{1} \leq \frac{1}{max ( {z}_{2 , k}^{Q} )} & Equation 36 \\ 0 \leq {δ}_{2} \leq min ( \frac{{A}_{k}}{{D}_{k}} ) & Equation 37\end{matrix}$$

In Equation 36, the upper limit of δ₁ is defined as 1/max (z^{Q}_{2,k}) across all demographics (k), where z₂ corresponds to the solution to z₂ determined in Equations 17-18 and Q corresponds to the prior distribution associated with third-party subscriber data. In Equation 37, the upper limit of δ₂ is defined by the minimum of third-party subscriber audience size (Aₖ) per impression duration (Dₖ) across all demographics within the third-party subscriber data. Example derivations of the search space {δ₁, δ₂} and corresponding Lagrangian solution derivation to Equations 30-31 are described in further detail in the “Example Lagrangian Solution” sub-section below.

Once the probability divergence determiner 230 has derived the solution to Equations 30-31 and the search space identifier 232 has identified the search space {δ₁, δ₂}, the divergence parameter solver 234 evaluates the divergence parameters based on z₀, z₁, z₂, and z₃ and the search space parameters using the iterator 236 and census-level output calculator 238 (block 606), verifying that the equality constraints are met to estimate census-level individual data for unique audience size {Xₖ}, impression counts {Tₖ}, and impression duration {Vₖ} (block 608). For example, the solution to Equations 30-31 can be expressed in accordance with Equations 38-43 (as described in the “Example Lagrangian Solution” sub-section, where derivations for c₀, c₁, c₂, c₃, c₄ are shown in Equations 79-83):

$$\begin{matrix}{X}_{k} = \frac{{c}_{4} {c}_{1}}{{c}_{3}} & Equation 38 \\ {T}_{k} = \frac{{c}_{4} {c}_{0}}{( {c}_{0} - 1 ) {c}_{3}} & Equation 39 \\ {V}_{k} = U ( \frac{1}{{c}_{3}} - \frac{1}{{c}_{2}} ) & Equation 40\end{matrix}$$

Equations 38-39 represent the census-level data estimates for vectors {Xₖ, Tₖ, Vₖ} when the iterator 236 iterates over the search space {δ₁, δ₂} established by the search space identifier 232 and the census-level output calculator 238 verifies that the equality constraints (e.g., corresponding to the reference total census-level impression counts (T) and the reference total census-level impression duration (V)) have been met. In some examples, the census-level output calculator 238 verifies that the equality constraint is valid for census-level audience metrics across all demographics. As such, access to the third-party subscriber data allows the audience metrics estimator 140 to estimate the census-level unique audience size, impression counts, and impression duration by solving for {Xₖ, Tₖ, Vₖ}.

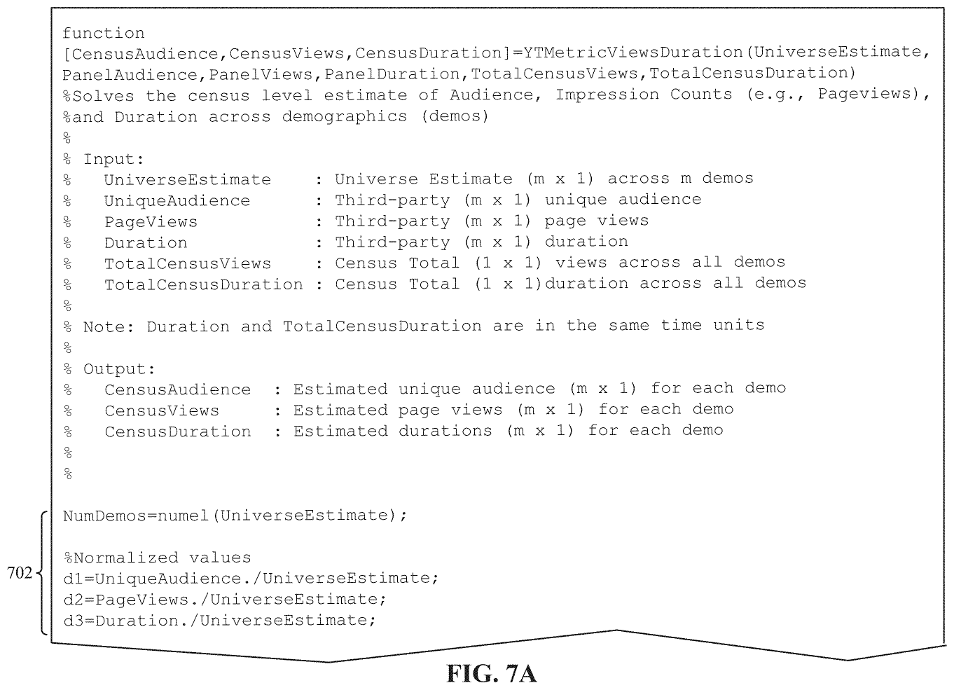

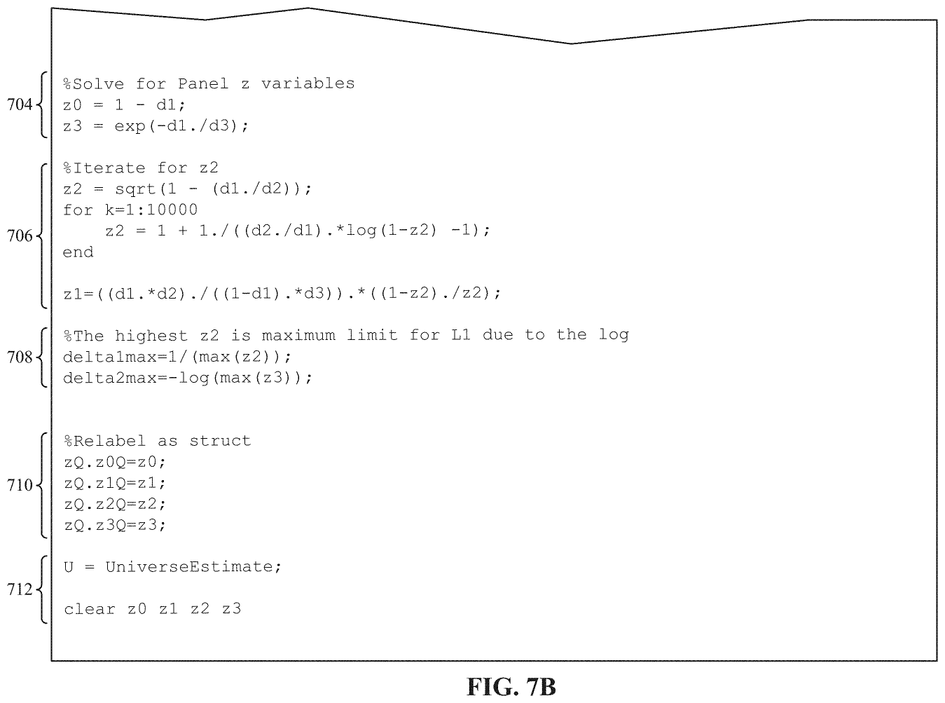

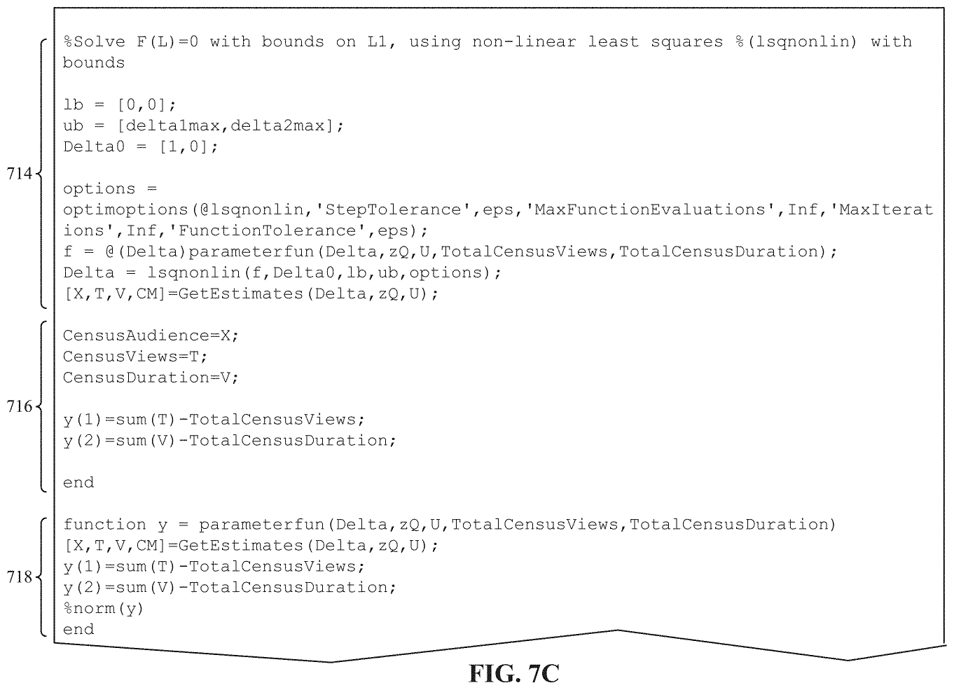

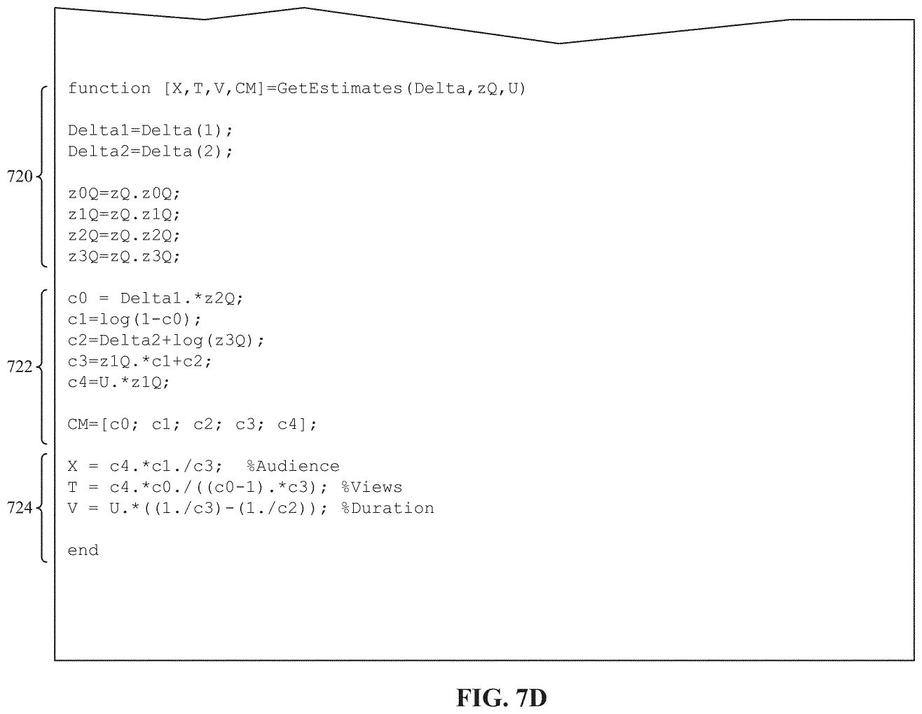

FIGS. 7A-7D include example programming code representative of machine readable instructions that may be executed to implement the example audience metrics estimator of FIGS. 1-2 to estimate census-level unique audience size 312, census-level impression count 314, and census-level impression duration 316 across multiple demographics based on third-party subscriber data 122 (e.g., audience size 124, impression counts 126, and impression duration 128) and census-level total impression count 134 and total impression duration 136. The example instructions of FIGS. 3-6 may be used in a MATLAB development environment. However, similar instructions may be employed to implement techniques disclosed herein in other development environments. In FIG. 7A, the example instructions at reference number 702 implement Equations 20-22 above to define the probability distribution of an individual being in the audience (d₁), the probability of having average impression counts (d₂), and the probability of having average impression durations (d₃). The example instructions at reference number 704 (FIG. 7B) define the solution to the person-specific distribution problem in terms of z notation based on Equations 13-14. The example instructions at reference number 706 define z₀ and z₃ directly, while the solution to z, is defined based on the solution to z₂, which can be solved using, for example, fixed-point iteration (e.g., the instructions based on Equations 16, 17, and 18). The example instructions at reference number 708 can be based on Equations 36-37 used to establish a search space {δ₁, δ₂} within bounds based on the z-notation-based census-level impression (z₂) and census-level duration (z₃) equality constraints. Example instructions at reference number 710 and 712 create a structure data-type to group related data (e.g., in an array), while also defining the universe estimate (e.g., total audience estimate), and clearing any values stored in z₀ thru z₃.

FIG. 7C shows example instructions at reference number 714 using non-linear least squares with bounds to solve the system of equations. For example, the upper bounds are set using the instructions at reference number 708. Example instructions at reference numbers 716-718 further define variables set forth to solve using the non-linear least squares method, while example instructions at reference numbers 720 and 722 are used to solve for census-level individual data for unique audience size {Xₖ}, impression counts {Tₖ}, and impression duration {Vₖ}, which is based on Equations 38-40 and Equations 79-83 (see “Example Lagrangian Solution” sub-section) implemented using example instructions at reference number 724. Although a non-linear least squares method is used to solve for census-level individual data, any other method suitable for solving the presented system of equations can be implemented.

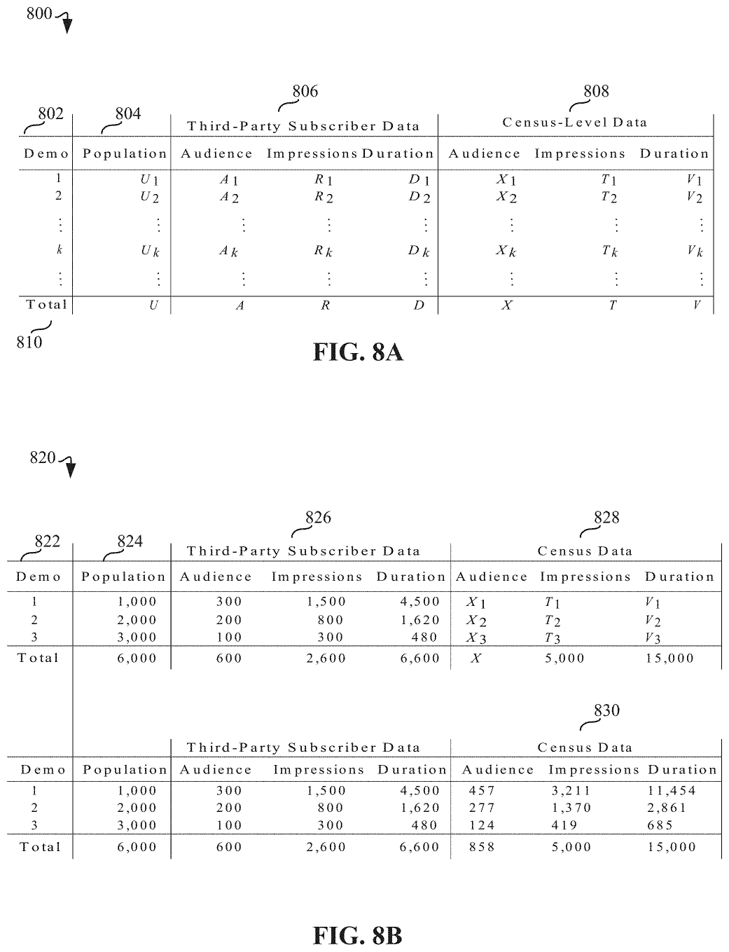

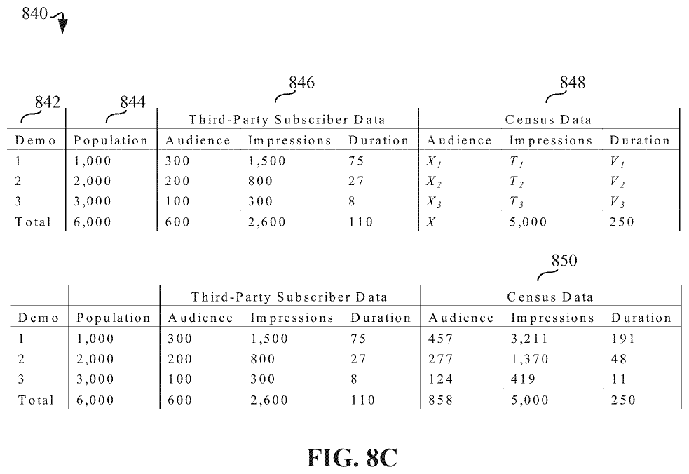

FIGS. 8A-8C include example set of variables used to define third-party subscriber and census-level data parameters used by the example audience metrics estimator of FIGS. 1-2 and example data sets providing third-party subscriber and census-level data. FIG. 8A sets forth a table 800 with the notations used throughout when determining census-level data based on third-party subscriber data. For example, reference number 802 identifies the demographics k (e.g., demographic 1 can refer to females aged 35-40, demographic 2 can refer to males aged 35-40, etc.). Reference number 804 identifies the population (e.g., universe audience (U) for each demographic, (Uₖ)). Reference number 806 identifies third-party subscriber data, including subscriber data for audience size (Aₖ), impression count (Rₖ), and impression duration (Dₖ). Reference number 808 identifies census-level data, including census-level unique audience (Xₖ), census-level impression count (Tₖ), and census-level impression duration (Vₖ). Reference number 810 identifies the total counts for each data group, including total universe audience (U), third-party total audience size (Aₖ), third-party total impression count (Rₖ), third-party total impression duration (D), census-level total audience size (X), census-level total impression count (T), and census-level total impression duration (V).

FIG. 8B shows a table 820 with an example set of data available from third-party subscriber data 122 of FIG. 1 and an example set of data available for census-level total impressions 134 and total impression duration 136 of FIG. 1. For example, a total of three different demographics (k) (reference number 822) are considered. The population 824 (e.g., universe audience, Uₖ) for each demographic (e.g., k=1-3) ranges from a total of 1,000 to a total of 3,000 for demographics 1-3, respectively. Third-party subscriber data 826 includes audience, impression, and duration values for each demographic, as well as values for total audience size, total impression counts, and total impression durations. Census-level data 828 includes only total impression counts (e.g., 5,000) and total impression durations (e.g., 15,000), whereas demographic-specific unique audience size, impression counts, and impression duration, as well as the total unique audience size, are all variables to be solved for using the methods described throughout this application and applied in the examples below. For example, using data available for the first demographic (k=1), Equations 19-22 can be applied to calculate the probability values specific to third-party subscriber data, as shown in Example 4:

$${d}_{0}^{Q} = \frac{1 , 000}{1 , 000} = 1 \\ {z}_{0}^{Q} = 0.7 \\ {d}_{1}^{Q} = \frac{300}{1 , 000} = 0.3 \to {z}_{1}^{Q} = 0.0107 \\ {d}_{2}^{Q} = \frac{1 , 500}{1 , 000} = 1.5 {z}_{2}^{Q} = 0.9301 \\ {d}_{3}^{Q} = \frac{4 , 500}{1 , 000} = 4.5 {z}_{3}^{Q} = 0.9355 \qquad Example 4$$

Using the example calculations of Example 4 above, the remaining probabilities can be determined for all demographics k to generate an example vector for each of the z^{Q} values (Example 5):

z₀^{Q}={0.7000,0.9000,0.9667}

z₁^{Q}={0.0107,0.0059,0.0038}

z₂^{Q}={0.9301,0.9034,0.8510}

z₃^{Q}={0.9355,0.8839,0.8119} Example 5

Example 6 shows an example search within the space defined by Equations 36-37 and the resulting example solution for {δ₁, δ₂}, based on constraints as defined by Equation 30:

$$1 \leq {δ}_{1} \leq \frac{1}{max ( {z}_{2 , k}^{Q} )} = \frac{1}{0.9301} - = 1.0752 \\ 0 \leq {δ}_{2} \leq min ( \frac{{A}_{k}}{{D}_{k}} ) = 0.0667 \\ constrained by {\sum }_{k = 1}^{K} {T}_{k} = T , {\sum }_{l = 1}^{K} {V}_{k} = V \\ \{ {δ}_{1} , {δ}_{2} \} = \{ 1 .0285 , 0.0267 \} \qquad Example 6$$

Based on Equations 79-83 (see “Example Lagrangian Solution” sub-section), solutions for the first demographic can be determined as follows in Example 7:

c₀=δ₁z₂^{Q}=+0.9565

c₁=log(1−c₀)=−3.1361

c₂=δ₂+log(z₃^{Q})=−0.0399

c₃=z₁^{Q}c₁+c₂=−0.0736

c₄=Uz₁^{Q}=+10.7395

Equations 38-40 can be used to determine the solutions to the census-level unique audience size (e.g., X₁), census-level impression counts (e.g., T₁), and census-level impression duration (e.g., V₁) for demographic k=1, as shown in Example 8:

$${X}_{k} = \frac{{c}_{4} {c}_{1}}{{c}_{3}} = 457.487 \\ {T}_{k} = \frac{{c}_{4} {c}_{0}}{( {c}_{0} - 1 ) {c}_{3}} = 3 , 211.278 \\ {V}_{k} = U ( \frac{1}{{c}_{3}} - \frac{1}{{c}_{2}} ) = 11 , 454.498 \qquad Example 8$$

Solutions for demographics k=2 and k=3 can similarly be identified using the approach described above, consistent with the vectors generated in Examples 9 and 10:

c₀={+0.9565,+0.9291,+0.8752}

c₁={−3.1361,−2.6459,−2.0812}

c₂={−0.0399,−0.0967,−0.1816}

c₃={−0.0736,−0.1123,−0.1895}

c₄={+10.7395,+11.7410,+11.3203} Example 9

X={457.4870,276.7211,124.3517}

T={3,211.3,1,369.6,419.1}

V={11,454,2,861,685} Example 10

The solution above is valid when the census-level constraints are met, as noted in Example 6. For example, the above solution (e.g., Example 10) is consistent with Σ T=5,000 and Σ V=15,000. The final values determined above are populated in the table 820 of FIG. 8B, such that census-level data 830 includes, for each demographic k=1, 2, and 3, the unique audience size (Xₖ), impression count (Tₖ), and impression duration (Vₖ).

FIG. 8C shows a table 840 with an example set of data 846 available from third-party subscriber data 122 of FIG. 1 and an example set of data 848 available for census-level total impressions 134 and total impression duration 136 of FIG. 1. In the example table 840 of FIG. 8C, the impression duration of the third-party subscriber data 846 has the same audience size data and impression counts data per demographics 842, as well as the same population size 844, as that of table 820 of FIG. 8B. Likewise, the total impression count (e.g., 5,000) for census-level data 848 remains the same, as does the total impression duration (e.g., 250). However, the impression duration of the third-party subscriber data 846 is much shorter per demographic 842 than that shown in table 820 of FIG. 4B. For example, if duration is changed to a new unit (e.g., by multiplying by a scaling factor), the final estimate of census durations should also scale by the same factor, while the estimate of audience size and impression counts should remain unchanged. For example, the third-party subscriber data 826 impression durations of FIG. 8B are divided by 60 (e.g., changing minutes to hours or seconds to minutes, depending on the original units), to yield the third-party subscriber data 846 impression durations per demographic k. The solution process as described for FIG. 8B remains the same for the data shown in FIG. 8C, with the set of probability vectors determined as shown in Example 11:

d₀^{Q}={1.0000,1.0000,1.0000}

d₁^{Q}={0.3000,0.1000,0.0333}

d₂^{Q}={1.5000,0.4000,0.1000}

d₃^{Q}={0.0750,0.0135,0.0027} Example 11

The z^{Q} vectors can be solved using the d^{Q} vectors of Example 11, the solutions for the z^{Q} vectors shown in Example 12:

z₀^{Q}={0.7000,0.9000,0.9667}

z₁^{Q}={0.6444,0.3522,0.2264}

z₂^{Q}={0.9301,0.9034,0.8510}

z₃^{Q}={0.0183,0.0006,0.0000}

As previously described, the search space and corresponding solution for {δ₁, δ₂} can be expressed as shown in Example 13 below:

$$1 \leq {δ}_{1} \leq \frac{1}{max ( {z}_{2 , k}^{Q} )} = \frac{1}{0.9301} = 1.0 \; 752 \\ 0 \leq {δ}_{2} \leq min ( \frac{{A}_{k}}{{D}_{k}} ) = 4 \\ \{ {δ}_{1} , {δ}_{2} \} = \{ 1.0285 , 1.6036 \} \qquad Example 13$$

Census-level estimates for the census-level data 848 of table 840 can be determined based on the calculations performed in Examples 11-13, such that the final vectors and census-level estimates satisfying the set constraints can be expressed as shown below in Examples 14 and 15:

c₀={0.9565,0.9291,0.8752}

c₁={−3.1361,−2.6459,−2.0812}

c₂={−2.3964,−5.8038,−10.8964}

c₃={−4.4172,−6.7357,−11.3676}

c₄={644.3716,704.4621,679.2174} Example 14

X={457.4870,276.7211,124.3517}

T={3,211.3,1,369.6,419.1}

V={190.9083,47.6795,11.4122} Example 15

Based on these results, the table 840 of FIG. 8C can be populated with the census-level data 850 for determined unique audience size (Xₖ), impression count (Tₖ), and impression duration (Vₖ) shown in Example 15.

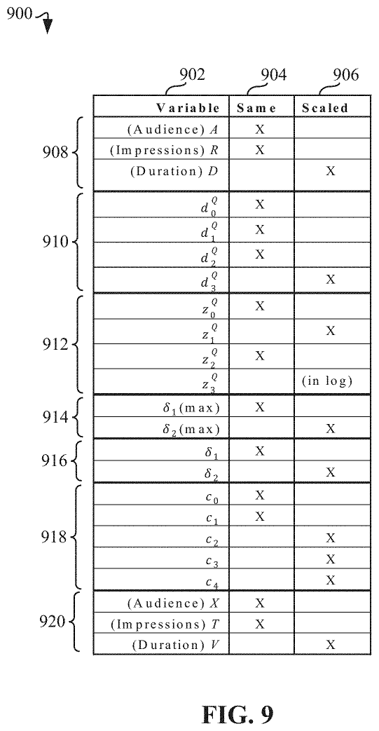

FIG. 9 illustrates table 900 with an example variable characterization based on scale independence and scale invariance, the example audience metrics estimator of FIGS. 1-2 generating estimations of census-level unique audience and impressions. For example, as described in the example solutions used to populate table 840 of FIG. 8C, as the time units used in impression duration (D) are scaled for any unit (e.g., seconds, minutes, hours, etc.), the estimated census-level impression duration (D) for each demographic also scales by the same factor, while the estimated audience size (A) and impression counts (R) can remain the same (e.g., see sub-section of table 900 denoted by reference number 908). As such, both audience and impression counts are independent of scale but impression duration is invariant to scale. The example table 900 includes a listing of variables 902, as well as whether the variables are independent of scale 904 (e.g., remain the same) or invariant to changes in scale 906 (e.g., are scaled). Table 900 shows how each variable is changed when duration is scaled (e.g., duration is scaled while all other variables remain the same). The example table 900 is further divided into sub-sections (e.g., reference numbers 908-920) to illustrate how changes in scale affect the variables used when determining census-level estimates. For example, reference number 910 indicates that the variable associated with the probability for the third-party subscriber data prior distribution (Q) that is associated with duration is scaled, while the remaining variables associated with audience size and impressions counts are not scaled. For example, the probability that a specific individual in the k^{th} demographic is a member of the third-party aggregated subscriber audience total (Aₖ) is defined as d₁^{Q}, the probability that a specific individual in the k^{th} demographic has impression counts in the third-party aggregated subscriber impression count total (Rₖ) is defined as d₂^{Q}, and the probability that a specific individual in the k^{th} demographic has an impression duration in the third-party aggregated impression duration total (Dₖ) is defined as d₃^{Q} (e.g., the only probability that is scaled, as shown in sub-section 910). Sub-section 912 of table 900 indicates that the z-notation based solutions for the third-party-based subscriber data are not affected by scaling for z₀^{Q} and z₂^{Q} while z₁^{Q} and z₃^{Q} are scaled. Likewise, the search space variable δ₁ bounds are not affected by scaling (e.g., sub-sections 914 and 916), while the δ₂ bounds are scaled, given that the 2 upper bound includes the duration variable (D) (e.g., based on Equation 37). Sub-section 918 indicates that the final solution to the census-level estimates {X, T, V} includes variables c₀ and c₁ that are not affected by scaling, while variables c₂, c₃, and c₄ are scaled, given that, based on Equations 79-83 (see “Example Lagrangian Solution” section), c₀ and c₁ solutions are based on variables that are not affected by scaling (e.g., z₂^{Q}), while variables c₂, c₃, and c₄ are based on variables that are scaled (e.g., z₁^{Q} and z₃^{Q}). Therefore, the final census-level estimates {X, T, V} includes audience size and impression counts that are not affected by the scaling, while the impression duration is scaled, as previously illustrated in the example solutions for table 840 of FIG. 8C.

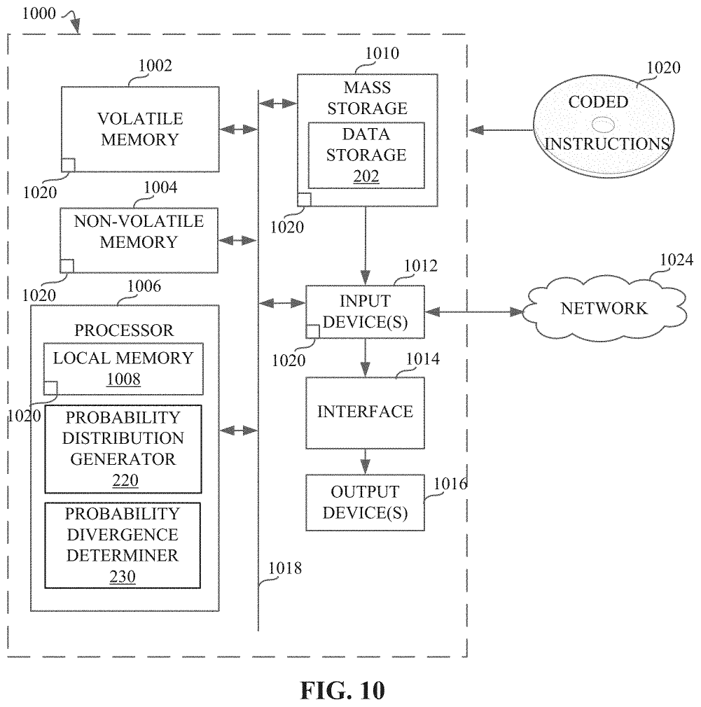

FIG. 10 is a block diagram of an example processing platform structured to execute the instructions of FIGS. 3-6 to implement the example audience metrics estimator of FIGS. 1-2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1000 of the illustrated example includes a processor 1006. The processor 1006 of the illustrated example is hardware. For example, the processor 1006 can be implemented by one or more integrated circuits, logic circuits, microprocessors, GPUs, DSPs, or controllers from any desired family or manufacturer. The hardware processor 1006 may be a semiconductor based (e.g., silicon based) device. In this example, the processor 1006 implements the example probability distribution generator 220 and the example probability divergence determiner 230 of FIG. 2.

The processor 1006 of the illustrated example includes a local memory 1008 (e.g., a cache). The processor 1006 of the illustrated example is in communication with a main memory including a volatile memory 1002 and a non-volatile memory 1004 via a bus 1018. The volatile memory 1002 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1004 may be implemented by flash memory and/or any other desired type of memory device. Access to the main memory 1002, 1004 is controlled by a memory controller.

The processor platform 1000 of the illustrated example also includes an interface circuit 1014. The interface circuit 1014 may be implemented by any type of interface standard, such as an Ethernet interface, a universal serial bus (USB), a Bluetooth® interface, a near field communication (NFC) interface, and/or a PCI express interface.

In the illustrated example, one or more input devices 1012 are connected to the interface circuit 1014. The input device(s) 1012 permit(s) a user to enter data and/or commands into the processor 1006. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1016 are also connected to the interface circuit 1014 of the illustrated example. The output devices 1016 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1014 of the illustrated example, thus, typically includes a graphics driver card, a graphics driver chip and/or a graphics driver processor.

The interface circuit 1014 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1024. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1010 for storing software and/or data. Examples of such mass storage devices 1010 include floppy disk drives, hard drive disks, compact disk drives, Blu-ray disk drives, redundant array of independent disks (RAID) systems, and digital versatile disk (DVD) drives. The mass storage device 1010 includes the example data storage 202 of FIG. 2.

Machine executable instructions 1020 represented in FIGS. 3-6 may be stored in the mass storage device 1020, in the volatile memory 1002, in the non-volatile memory 1004, and/or on a removable non-transitory computer readable storage medium such as a CD or DVD.

### Example Lagrangian Solution

The Lagrangian across all K demographics, including the census-level views and duration constrains as well as multipliers, is defined using Equations 29 and 31, as previously described above and reproduced below:

KL(P:Q)=Σₖ₌₁^{K}Uₖ(KL(Pₖ:Qₖ)) Equation 29

[symbol]

=KL(P:Q)−λ₁(Σₖ₌₁^{K}Tₖ−T)−λ₂(Σₖ₌₁^{K}Vₖ−V) Equation 31

Given that each demographic is independent except for census-based constraints, the subscript k is dropped in the derivation presented below describing the solution based on a single demographic to illustrate the derivation process. Equations 29 and 31 can be expanded in accordance with Equation 41:

$$U ( KL ( P \text{:} Q ) ) = ( {d}_{0}^{P} ) [ log ( {z}_{0}^{P} ) - log ( {z}_{0}^{Q} ) ] … + ( {d}_{1}^{P} ) [ log ( {z}_{1}^{P} ) - log ( {z}_{1}^{Q} ) ] … + ( {d}_{2}^{P} ) [ log ( {z}_{2}^{P} ) - log ( {z}_{2}^{Q} ) ] … + ( {d}_{3}^{P} ) [ log ( {z}_{3}^{P} ) - log ( {z}_{3}^{Q} ) ] \qquad Equation 41$$

Assuming that all z^{Q} are solved based on third-party subscriber data, these can serve as reference constants for each demographic. Expressions for z^{P}(e.g., census-level data, P) can be substituted in terms of d^{P} variables, as shown in Equations 42-45:

$$\begin{matrix}{z}_{0}^{P} = 1 - {d}_{1}^{P} & Equation 42 \\ {z}_{1}^{P} = ( \frac{{d}_{1}^{P} {d}_{2}^{P}}{( 1 - {d}_{1}^{P} ) {d}_{3}^{P}} ) ( \frac{1 - {z}_{2}^{P}}{{z}_{2}^{P}} ) & Equation 43 \\ \frac{- {z}_{2}^{P}}{( 1 - {z}_{2}^{P} ) log ( 1 - {z}_{2}^{P} )} = \frac{{d}_{2}^{P}}{{d}_{1}^{P}} & Equation 44 \\ {z}_{3}^{P} = exp ( \frac{- {d}_{1}^{P}}{{d}_{3}^{P}} ) & Equation 45\end{matrix}$$

The census-level based data demographic variables can be further defined, as shown in Equations 46-49 (e.g., described above in connection with Equations 19-22). For example, the probability that a specific individual is a member of the census-level unique audience total (X) is defined as X/U, the probability that a specific individual has impression counts in the census-level impression count total (T) is defined as T/U, and the probability that a specific individual has an impression duration in the census-level impression duration total (i) is defined as V/U:

$$\begin{matrix}{d}_{0}^{P} = 1 & Equation 46 \\ {d}_{1}^{P} = \frac{X}{U} & Equation 47 \\ {d}_{2}^{P} = \frac{T}{U} & Equation 48 \\ {d}_{3}^{P} = \frac{V}{U} & Equation 49\end{matrix}$$

The Lagrangian can further be expressed according to Equation 50 below using Equations 46-49:

$${ℒ}_{k} = U ( KL ( P \text{:} Q ) ) = - {λ}_{1} T - {λ}_{2} V + X log ( \frac{TX ( {z}_{2}^{P} - 1 )}{V {z}_{2}^{P} ( X - U )} ) + T log ( {z}_{2}^{P} ) - T log ( {z}_{2}^{Q} ) + U log ( 1 - \frac{X}{U} ) - U log ( {z}_{0}^{Q} ) + V log ( {e}^{\frac{- X}{V}} ) - V log ( {z}_{3}^{Q} ) - X log ( {z}_{1}^{Q} ) \qquad Equation 50$$

The partials within each census variable {X, T, V} can be obtained as shown below in Equations 51-53:

$$\begin{matrix}\frac{\partial {ℒ}_{k}}{\partial X} = log ( \frac{TX ( {z}_{2}^{P} - 1 )}{V {z}_{2}^{P} ( X - U )} ) + ( \frac{( T ( {z}_{2}^{P} - 1 ) + X )}{( {z}_{2}^{P} - 1 ) {z}_{2}^{P}} ) \frac{\partial {z}_{2}^{P}}{\partial X} - log ( {z}_{1}^{Q} ) - 1 & Equation 51 \\ \frac{\partial {ℒ}_{k}}{\partial T} = - {λ}_{1} + ( \frac{( T ( {z}_{2}^{P} - 1 ) + X )}{( {z}_{2}^{P} - 1 ) {z}_{2}^{P}} ) \frac{\partial {z}_{2}^{P}}{\partial T} + \frac{X}{T} + log ( {z}_{2}^{P} ) - log ( {z}_{2}^{Q} ) & Equation 52 \\ \frac{\partial {ℒ}_{k}}{\partial V} = - {λ}_{2} + ( \frac{( T ( {z}_{2}^{P} - 1 ) + X )}{( {z}_{2}^{P} - 1 ) {z}_{2}^{P}} ) \frac{\partial {z}_{2}^{P}}{\partial V} + log ( {e}^{\frac{- X}{V}} ) - log ( {z}_{3}^{Q} ) & Equation 53\end{matrix}$$

In Equations 51-53, the z^{P}₂ terms are retained, with all of their partial derivations with respect to each variable also presented

$$( e . g . , ( \frac{\partial {z}_{2}^{P}}{\partial X} , \frac{\partial {z}_{2}^{P}}{\partial T} , \frac{\partial {z}_{2}^{P}}{\partial V} ) ) .$$

The expression for z₂ (e.g., subscript P suppressed for simplification) can be expressed in accordance with Equation 54 below:

$$\frac{- {z}_{2}}{( 1 - {z}_{2} ) log ( 1 - {z}_{2} )} = \frac{T}{X} \qquad Equation 54$$

While z₂ is not solved directly using Equation 54, implicit differentiation can be used to express the census-level unique audience total (X), the census-level impression count total (7), and the census-level impression duration total (V) using Equations 55, 56, and 57, respectively:

$$\begin{matrix}X \text{:} ( \frac{( {z}_{2} + log ( 1 - {z}_{2} ) )}{{( {z}_{2} - 1 )}^{2} {log}^{2} ( 1 - {z}_{2} )} ) \frac{\partial {z}_{2}}{\partial X} = \frac{T}{{X}^{2}} & Equation 55 \\ T \text{:} ( - \frac{( {z}_{2} + log ( 1 - {z}_{2} ) )}{{( {z}_{2} - 1 )}^{2} {log}^{2} ( 1 - {z}_{2} )} ) \frac{\partial {z}_{2}}{\partial T} = \frac{1}{X} & Equation 56 \\ V \text{:} ( \frac{( {z}_{z} + log ( 1 - {z}_{2} ) )}{( {z}_{2} - 1 ) log ( 1 - {z}_{2} )} ) \frac{\partial {z}_{2}}{\partial V} = 0 & Equation 57\end{matrix}$$

The resulting partial derivative of Equations 55-57 can be solved as a function of {T, X, z₂} for each expression individually, in accordance with Equations 58-60:

$$\begin{matrix}X \text{:} \frac{\partial {z}_{2}}{\partial X} = ( \frac{T}{{X}^{2}} ) ( \frac{{( {z}_{2} - 1 )}^{2} {log}^{2} ( 1 - {z}_{2} )}{( {z}_{2} + {log}^{2} ( 1 - {z}_{2} ) )} ) & Equation 58 \\ T \text{:} \frac{\partial {z}_{2}}{\partial X} = ( \frac{1}{X} ) ( - \frac{{( {z}_{2} - 1 )}^{2} {log}^{2} ( 1 - {z}_{2} )}{( {z}_{2} + {log}^{2} ( 1 - {z}_{2} ) )} & Equation 59 \\ V \text{:} \frac{\partial {z}_{2}}{\partial V} = 0 & Equation 60\end{matrix}$$

While z₂ is again not solved for directly, its partial derivatives are in terms of the value of z₂. Therefore, to eliminate the term log(1−z₂), Equation 56 can be rewritten as Equation 61 below:

$$\frac{- {z}_{2}}{( 1 - {z}_{2} ) log ( 1 - {z}_{2} )} = \frac{T}{X} ⇒ log ( 1 - {z}_{2} ) = \frac{- X {z}_{2}}{T ( 1 - {z}_{2} )} \qquad Equation 61$$

Equation 61 can be further substituted into Equations 58-60 to reduce the partial derivatives in terms of z₂ alone, as shown in Equations 62-64 below:

$$\begin{matrix}X \text{:} \frac{\partial {z}_{2}}{\partial X} = \frac{( {z}_{2} - 1 ) {z}_{2}}{T ( {z}_{2} - 1 ) + X} & Equation 62 \\ T \text{:} \frac{\partial {z}_{2}}{\partial X} = - \frac{X ( {z}_{2} - 1 ) {z}_{2}}{T ( T ( {z}_{2} - 1 ) + X )} & Equation 63 \\ V \text{:} \frac{\partial {z}_{2}}{\partial V} = 0 & Equation 64\end{matrix}$$

Using Equations 62-64, the Lagrangian derivatives in Equations 51-53 can further be simplified as shown in Equations 65-67 below:

$$\begin{matrix}\frac{\partial {ℒ}_{k}}{\partial X} = log ( \frac{TX ( {z}_{2} - 1 )}{V {z}_{2} ( X - U )} ) - log ( {z}_{1}^{Q} ) & Equation 65 \\ \frac{\partial {ℒ}_{k}}{\partial T} = - {λ}_{1} + log ( {z}_{2} ) - log ( {z}_{2}^{Q} ) & Equation 66 \\ \frac{\partial {ℒ}_{k}}{\partial V} = - {λ}_{2} + log ( {e}^{\frac{- X}{V}} ) - log ( {z}_{3}^{Q} ) & Equation 67\end{matrix}$$

Using Equation 66, the term for z₂ can now be expressed as Equation 68 (e.g., when Equation 66 is set equal to 0), such that it becomes a parameter:

z₂=z₂^{Q}e^{λ}^{₁} Equation 68

Given that each partial derivative should be in terms of {X, T, V}, Equation 66 can be rewritten such that all three partial derivatives of Equations 65-67 can be solved simultaneously when all three expressions are equal to zero. As such, Equations 69-70 are used to make further substitutions into Equation 66, yielding Equation 71:

$$\begin{matrix} {z}_{2} = exp ( log ( {z}_{2} ) ) for {z}_{2} > 0 & Equation 69 \\ \frac{- {z}_{2}}{( 1 - {z}_{2} ) log ( 1 - {e}^{a} )} = \frac{T}{X} ⇒ a = log ( {z}_{2} ) = log ( 1 - {e}^{\frac{{Xz}_{2}}{T ( {z}_{2} - 1 )}} ) & Equation 70 \\ \frac{\partial {ℒ}_{k}}{\partial T} = - {λ}_{1} + ( log ( 1 - {e}^{\frac{{Xz}_{2}}{T ( {z}_{2} - 1 )}} ) ) - log ( {z}_{2}^{Q} ) & Equation 71\end{matrix}$$

Further adjustments can be made by substituting Equation 68 into the three expressions for the partial derivatives in Equations 65, 67, and 71. The resulting Equations 72-74 are expressions in terms of the three variables {X, T, V} and two parameters {λ₁, λ₂}:

$$\begin{matrix}\frac{\partial {ℒ}_{k}}{\partial X} = log ( \frac{TX ( {z}_{2}^{Q} {e}^{{λ}_{1}} - 1 )}{{Vz}_{2}^{Q} {e}^{{λ}_{1}} ( X - U )} ) - log ( {z}_{1}^{Q} ) & Equation 72 \\ \frac{\partial {ℒ}_{k}}{\partial T} = - {λ}_{1} + ( log ( 1 - {e}^{\frac{{e}^{{λ}_{1} {Xz}_{2}^{Q}}}{T ( {e}^{{λ}_{1}} {z}_{2}^{Q} - 1 )}} ) ) - log ( {z}_{2}^{Q} ) & Equation 73 \\ \frac{\partial {ℒ}_{k}}{\partial V} = - {λ}_{2} + log ( {e}^{\frac{- X}{V}} ) - log ( {z}_{3}^{Q} ) & Equation 74\end{matrix}$$

Equations 72-74 can therefore be solved for each variable when all expressions are equal to zero, resulting in Equations 75-77 below:

$$\begin{matrix} X = \frac{{Uz}_{1}^{Q} log ( 1 - {z}_{2}^{Q} {e}^{{λ}_{1}} )}{{z}_{1}^{Q} log ( 1 - {z}_{2}^{Q} {e}^{{λ}_{1}} ) + {λ}_{2} + log ( {z}_{3}^{Q} )} & Equation 75 \\ T = \frac{{Uz}_{1}^{Q} {z}_{2}^{Q} {e}^{{λ}_{1}}}{( {z}_{2}^{Q} {e}^{{λ}_{1}} - 1 ) ( {z}_{1}^{Q} log ( 1 - {z}_{2}^{Q} {e}^{{λ}_{1}} ) + {λ}_{2} + log ( {z}_{3}^{Q} ) )} & Equation 76 \\ V = U ( \frac{1}{{z}_{1}^{Q} log ( 1 - {z}_{2}^{Q} {e}^{{λ}_{1}} ) + {λ}_{2} + log ( {z}_{Q}^{3} )} - \frac{1}{{λ}_{2} + log ( {z}_{3}^{Q} )} ) & Equation 77\end{matrix}$$

The final result for each demographic can be obtained by simplifying the derived expressions, first through a change in notation (e.g., from λ to δ, as shown in Equation(s) 78), followed by defining new variables for parts of Equations 75-77 (e.g., variables c₀-c₄, as shown in Equations 79-83):

δ₁=e^{λ}^{_{1;δ}}₂=λ₂ Equation(s) 78

c₀=δ₁z₂^{Q} Equation 79

c₁=log(1−c₀) Equation 80

c₂=δ₂+log(z₃^{Q}) Equation 81

c₃=z₁^{Q}c₁+c₂ Equation 82

c₄=Uz₁^{Q} Equation 83

Based on Equations 79-83 below, the solutions for each demographic to census-level unique audience (X), census-level impression count (T), and census-level impression duration (V), can be expressed as Equations 84-86 below:

$$\begin{matrix}X = \frac{{c}_{4} {c}_{1}}{{c}_{3}} & Equation 84 \\ T = \frac{{c}_{4} {c}_{0}}{( {c}_{0} - 1 ) {c}_{3}} & Equation 85 \\ V = U ( \frac{1}{{c}_{3}} - \frac{1}{{c}_{2}} ) & Equation 86\end{matrix}$$

Since {λ₁, λ₂}={0, 0} returns the census data to the third-party subscriber data, equivalent neutral values for δ are {δ₁, δ₂}={1, 0}. To find the domain of valid {δ₁, δ₂} across all demographics, the expression 1−c₀ within the logarithm should be positive for all demographics, such that in Equation 87 below the maximum is over z^{Q}₂ across all demographics. Likewise, the minimum of audience per duration across all demographics within the third-party subscriber data can be expressed as Equation 88:

$$\begin{matrix}1 \leq {δ}_{1} \leq \frac{1}{max ( {z}_{2}^{Q} )} & Equation 87 \\ 0 \leq {δ}_{2} \leq min ( \frac{A}{D} ) & Equation 88\end{matrix}$$

As such, for scaling down instead of scaling up, the lower limits of δ are no longer finite, but become unbounded to negative infinity (−∞) for each.

From the foregoing, it will be appreciated that example systems, methods, and apparatus allow for use of third-party subscriber-level audience metrics that provide partial information on impression counts, impression duration, and unique audience sizes to overcome the anonymity of census-level impressions when estimating total unique audience sizes for media. In the examples disclosed herein, an audience metrics estimator determines census-level unique audience, impression counts, and impression durations across demographics by generating probability distributions and determining probability divergences that exist between the third-party census-level data and subscriber data, and establishing a search space within bounds based on equality constraints, such that iteration over the search space until the equality constraints are satisfied yields census-level individual data estimates. The examples disclosed herein determine audience sizes and durations for different demographics at the census level using third-party-derived partial audience metrics and total census-level durations. The examples disclosed herein permit estimations that are logically consistent with all constraints, scale independence and invariance. Furthermore, the examples disclosed herein permit monitoring media impressions of any one or more media types.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus to determine census-level audience metrics across demographics, the apparatus comprising:
a distribution parameter solver to initialize distribution parameter values for a probability of an individual within a demographic being included in a subscriber audience for the demographic, having a first average impression count, and having a first average impression duration, the subscriber audience having a first subscriber audience size;
a divergence parameter solver to determine divergence parameter values between (i) the subscriber audience size, the first impression count, and the first impression duration and (ii) a census-level audience size, a second impression count, and a second impression duration based on the initialized distribution parameter values;
a search space identifier to identify a search space within bounds based on a census-level total impression count and a census-level total impression duration, the search space to define an equality constraint; and
an iterator to iterate over the search space until census-level outputs based on the divergence parameter values converge to the equality constraint, the census-level outputs including census-level unique audience size, census-level impression count, and census-level impression duration for the demographic.

2. The apparatus of claim 1, further including a database to:
store, from a database proprietor, subscriber data including the first subscriber audience size, a the first impression count, and the first impression duration for the demographic;
access, from a user device, a user-based impression count and a user-based impression duration; and
store census-level data including the census-level total impression count and the census-level total impression duration, the census-level data total impression count and the census-level total impression duration including the user-based impression count and the user-based impression duration.

3. The apparatus of claim 2, wherein the census-level audience metrics are media audience metrics, the media including at least one of a webpage, an advertisement, or a video.

4. The apparatus of claim 2, wherein the census-level data includes data logged by an audience measurement entity.

5. The apparatus of claim 2, wherein the divergence parameter solver is to determine the divergence parameter values based on a Kullback-Leibler probability divergence.

6. The apparatus of claim 2, wherein the equality constraint is valid for the census-level audience metrics across all demographics represented in the subscriber data.

7. The apparatus of claim 1, wherein the subscriber audience size is provided by a database proprietor.

8. A method to determine census-level audience metrics across demographics, the method comprising:
initializing distribution parameter values for a probability of an individual within a demographic being included in a subscriber audience for the demographic, having a first average impression count, and having a first average impression duration, the subscriber audience having a first subscriber audience size;
determining divergence parameter values between (i) the subscriber audience size, the first impression count, and the first impression duration and (ii) a census-level audience size, a second impression count, and a second impression duration based on the initialized distribution parameter values;
identifying a search space within bounds based on a census-level total impression count and a census-level total impression duration, the search space to define an equality constraint; and
iterating over the search space until census-level outputs based on the divergence parameter values converge to the equality constraint, the census-level outputs including census-level unique audience size, census-level impression count, and census-level impression duration for the demographic.

9. The method of claim 8, further including:
storing, from a database proprietor, subscriber data including the first subscriber audience size, a the first impression count, and the first impression duration for the demographic;
accessing, from a user device, a user-based impression count and a user-based impression duration; and
storing census-level data including the census-level total impression count and the census-level total impression duration, the census-level data total impression count and the census-level total impression duration including the user-based impression count and the user-based impression duration.

10. The method of claim 9, wherein the census-level audience metrics are media audience metrics, the media including at least one of a webpage, an advertisement, or a video.

11. The method of claim 9, wherein the census-level data includes data logged by an audience measurement entity.

12. The method of claim 9, further including determining the divergence parameter values based on a Kullback-Leibler probability divergence.

13. The method of claim 9, wherein the equality constraint is valid for the census-level audience metrics across all demographics represented in the subscriber data.

14. The method of claim 8, wherein the subscriber audience size is provided by a database proprietor.

15. A non-transitory computer readable storage medium comprising instructions that, when executed, cause a processor to at least:
initialize distribution parameter values for a probability of an individual within a demographic being included in a subscriber audience for the demographic, having a first average impression count, and having a first average impression duration, the subscriber audience having a first subscriber audience size;
determine divergence parameter values between (i) the subscriber audience size, the first impression count, and the first impression duration and (ii) a census-level audience size, a second impression count, and a second impression duration based on the initialized distribution parameter values;
identify a search space within bounds based on a census-level total impression count and a census-level total impression duration, the search space to define an equality constraint; and
iterate over the search space until census-level outputs based on the divergence parameter values converge to the equality constraint, the census-level outputs including census-level unique audience size, census-level impression count, and census-level impression duration for the demographic.

16. The non-transitory computer readable storage medium of claim 15, wherein the instructions, when executed, cause a processor to:
store, from a database proprietor, subscriber data including the first subscriber audience size, a the first impression count, and the first impression duration for the demographic;
access, from a user device, a user-based impression count and a user-based impression duration; and
store census-level data including the census-level total impression count and the census-level total impression duration, the census-level data total impression count and the census-level total impression duration including the user-based impression count and the user-based impression duration.

17. The non-transitory computer readable storage medium of claim 16, wherein the instructions, when executed, cause a processor to determine the divergence parameter values based on a Kullback-Leibler probability divergence.

18. The non-transitory computer readable storage medium of claim 16, wherein the instructions, when executed, cause a processor to verify the equality constraint is valid for the census-level audience metrics across all demographics represented in the subscriber data.

19. The non-transitory computer readable storage medium of claim 16, wherein the instructions, when executed, cause a processor to retrieve census-level data, the census-level data including data logged by an audience measurement entity.

20. The non-transitory computer readable storage medium of claim 15, wherein the instructions, when executed, cause a processor to retrieve the subscriber audience size from a database proprietor.
